(19) United States
(12) Patent Application Publication
(10) Pub. No.: US 2016/0092867 A1
(43) Pub. Date: Mar. 31, 2016

(54) SYSTEMS AND METHODS FOR ADMINISTERING MOBILE APPLICATIONS USING PRE-LOADED TOKENS

(71) Applicant: The Toronto-Dominion Bank, Mississauga (CA)

(72) Inventors: Hisham I. SALAMA, Charlotte, NC (US); Edward LOUNSBURY, Toronto (CA); Paul Mon-Wah CHAN, Markham (CA)

(73) Assignee: The Toronto-Dominion Bank

(21) Appl. No.: 14/869,869

(22) Filed: Sep. 29, 2015

Related U.S. Application Data
(60) Provisional application No. 62/056,776, filed on Sep. 29, 2014.

(51) Int. Cl. G06Q 20/36; G06Q 20/42

(52) U.S. Cl. CPC G06Q 20/363; G06Q 20/3672; G06Q 20/42

(57) ABSTRACT

The disclosed embodiments include computerized methods and systems that administer mobile application programs using tokens “pre-loaded” with data. For example, the disclosed embodiments may adaptively identify and pre-load mobile wallets with loyalty products of potential interest to customers. In one aspect, the disclosed embodiments may identify one or more loyalty products that may be of potential interest to a user, and further, that may be missing from the user's mobile wallet. The disclosed embodiments may determine that the user fails to hold a corresponding one of the missing loyalty products, and may transmit user information to an issuer system as a request to acquire the corresponding missing loyalty product from an issuer. Upon receipt of information confirming the acquisition of the corresponding missing loyalty product, the disclosed embodiments may generate a token based on the newly-acquired loyalty product and push the token to a user device.

### CROSS-REFERENCE TO RELATED APPLICATIONS

This application claims the benefit of U.S. Provisional Patent Application No. 62/056,776, filed Sep. 29, 2014, which is expressly incorporated by reference herein, in its entirety.

### BACKGROUND

1. Technical Field

The disclosed embodiments generally relate to computerized systems and methods for administering mobile application programs, and more particularly, and without limitation, to computerized systems and methods that administer the mobile application programs using pre-loaded tokens.

2. Background Information

Today, mobile payment products, such as mobile wallet applications executed by mobile devices, enable users to purchase goods and services at various retailers. While eliminating the need to carry a physical wallet including cash and other payment instruments, such as credit cards and debit cards, the multiple authentication and configuration steps required of typical mobile wallet applications may discourage many users from adopting mobile wallet technologies. For example, in order to establish a mobile wallet on a mobile device, a user may be required to download the mobile wallet application from a financial institution, register for mobile wallet services provided by the financial institution, and only after a successful registration, identify and manually load information identifying each of the user's credit cards, debit cards, and rewards and loyalty cards into the mobile wallet application. The multiple registration and configuration steps characteristic of today's mobile wallet technologies may discourage many users from adopting mobile wallets for their daily purchases, despite their convenience.

### SUMMARY

The disclosed embodiments include computer-implemented systems and methods that adaptively administer application programs using pre-loaded tokens.

In some embodiments, an apparatus includes at least one processor and a memory storing executable instructions that, when executed by the at least one processor, cause the at least one processor to perform the step of identifying one or more financial products of potential interest to a user. In some aspects, the identification may be based on transaction data associated with the user, and the financial products may be eligible for inclusion within a mobile wallet administered by an application program executed by a device of user. The executed instructions may further cause the at least one processor to perform the steps of determining whether the user holds a corresponding one of the financial products, and when the user fails to hold the corresponding financial product, transmitting, to a system associated with an issuer of the corresponding financial product, a request to acquire the corresponding financial product on behalf of the user. The executed instructions may also cause the at least one processor to perform the steps of receiving, from the issuer system, information associated with the corresponding financial product acquired on behalf the user, generating a mobile wallet token based at least the information identifying the corresponding financial product, and transmitting the generated mobile wallet token to the user device.

The disclosed embodiments may further include a computer-implemented method that identifies, using at least one processor, one or more financial products of potential interest to a user. In some aspects, the identification may be based on transaction data associated with the user, and the financial products may be eligible for inclusion within a mobile wallet administered by an application program executed by a device of user. The method also includes determining, using the at least one processor, whether the user holds a corresponding one of the financial products, and when the user fails to hold the corresponding financial product, transmitting, using the at least one processor, and to a system associated with an issuer of the corresponding financial product, a request to acquire the corresponding financial product on behalf of the user. The method further receives, using the at least one processor, and from the issuer system, information associated with the corresponding financial product acquired on behalf the user, generates, using the at least one processor, a mobile wallet token based at least the information identifying the corresponding financial product, and transmits, using the at least one processor, the generated mobile wallet token to the user device.

In addition, the disclosed embodiments include a tangible, non-transitory computer-readable medium storing instructions that, when executed by at least one processor, cause the at least one processor to perform a method. The method includes identifying one or more financial products of potential interest to a user. In some aspects, the identification may be based on transaction data associated with the user, and the financial products may be eligible for inclusion within a mobile wallet administered by an application program executed by a device of user. The method also includes determining whether the user holds a corresponding one of the financial products, and when the user fails to hold the corresponding financial product, transmitting, to a system associated with an issuer of the corresponding financial product, a request to acquire the corresponding financial product on behalf of the user. The method further receives, from the issuer system, information associated with the corresponding financial product acquired on behalf the user, generates a mobile wallet token based at least the information identifying the corresponding financial product, and transmits the generated mobile wallet token to the user device.

It is to be understood that both the foregoing general description and the following detailed description are exemplary and explanatory only, and are not restrictive of the disclosed embodiments as claimed. Further, the accompanying drawings, which are incorporated in and constitute a part of this specification, illustrate aspects of the present disclosure and together with the description, serve to explain principles of the disclosed embodiments as set forth in the accompanying claims.

### BRIEF DESCRIPTION OF THE DRAWINGS

FIG. 1 is a diagram of an exemplary computing environment, consistent with disclosed embodiments.

FIG. 2 is a flowchart of an exemplary process for loading a mobile wallet with eligible financial products, consistent with disclosed embodiments.

FIG. 3 is a flowchart of an exemplary process for identifying financial products eligible for inclusion in a mobile wallet, consistent with disclosed embodiments.

FIG. 4 is a flowchart of an exemplary process for loading a mobile wallet with eligible financial products, consistent with disclosed embodiments

FIG. 5 illustrates an exemplary interface of a mobile wallet application, consistent with disclosed embodiments.

FIG. 6 is a flowchart of an exemplary process for loading a mobile wallet with eligible loyalty products, consistent with disclosed embodiments.

FIGS. 7A and 7B illustrate an exemplary interface of a mobile wallet application, consistent with disclosed embodiments.

FIG. 8 is a flowchart of an additional exemplary process for loading a mobile wallet with eligible loyalty products, consistent with disclosed embodiments.

### DESCRIPTION OF THE EMBODIMENTS

Reference will now be made in detail to the disclosed embodiments, examples of which are illustrated in the accompanying drawings. The same reference numbers in the drawings and this disclosure are intended to refer to the same or like elements, components, and/or parts.

In this application, the use of the singular includes the plural unless specifically stated otherwise. In this application, the use of “or” means “and/or” unless stated otherwise. Furthermore, the use of the term “including,” as well as other forms such as “includes” and “included,” is not limiting. In addition, terms such as “element” or “component” encompass both elements and components comprising one unit, and elements and components that comprise more than one subunit, unless specifically stated otherwise. Additionally, the section headings used herein are for organizational purposes only, and are not to be construed as limiting the subject matter described.

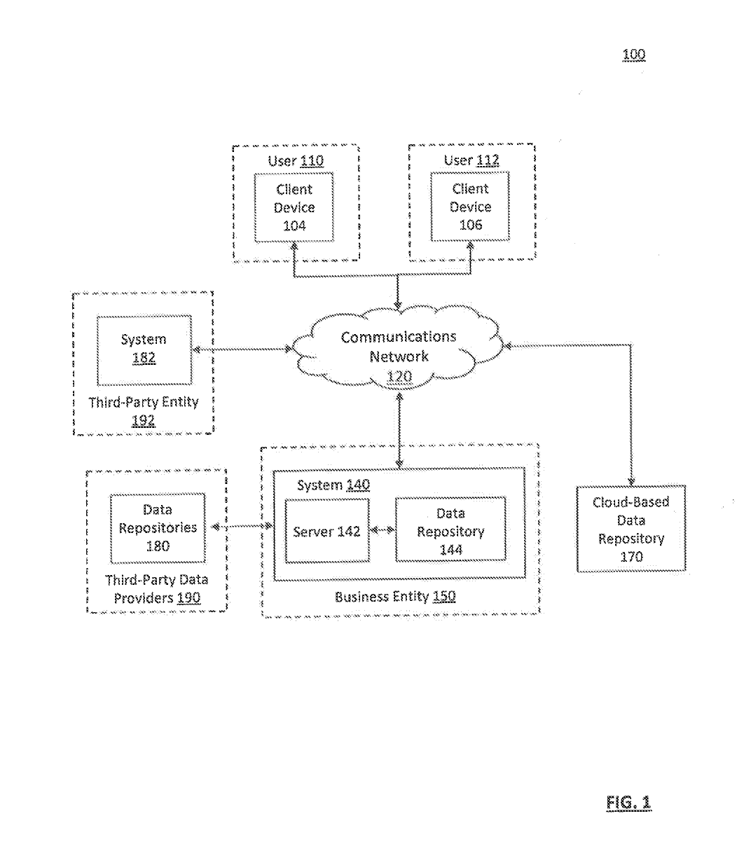

FIG. 1 illustrates an exemplary computing environment 100 consistent with certain disclosed embodiments. In one aspect, computing environment 100 may include client devices 104 and 106, systems 140 and 182, cloud-based data repository 170, and data repositories 180, and a communications network 120 connecting one or more of the components of environment 100.

In one embodiment, client devices 104 and 106 may be computing devices, such as, but not limited to, a personal computer, a laptop computer, a tablet computer, a notebook computer, a hand-held computer, a personal digital assistant, a portable navigation device, a mobile phone, a smart phone, a wearable computing device (e.g., a smart watch, a wearable activity monitor, wearable smart jewelry, and glasses and other optical devices that include optical head-mounted displays (OHMDs), an embedded computing device (e.g., in communication with a smart textile or electronic fabric), and any other type of computing device that may be configured to store data and software instructions, execute software instructions to perform operations, and/or display information on a display device(s), consistent with disclosed embodiments. In certain embodiments, client devices 104 and 106 may be associated with one or more users, such as users 110 and 112. For instance, users may operate client devices 104 and 106, and may do so to cause client devices 104 and 106 to perform one or more operations consistent with the disclosed embodiments. In some aspects, client devices 104 and 106 may include a smart card, chip card, integrated circuit card (ICC), and/or other card having an embedded integrated circuit. By way of example, systems consistent with the disclosed embodiments (e.g., system 140) may be configured to track one or more secured locations accessed by users 110 and 112 (e.g., a street entrance to a secured apartment building) using a smart card incorporated into client devices 104 and 106.

Client devices 104 and 106 may include known computing device components. For instance, client devices 104 and 106 may include one or more tangible, non-transitory memories that store data and/or software instructions, and one or more processors configured to execute software instructions. Client device 104 may include one or more display devices that display information to a user and one or more input device(s) to allow the user to input information to client device 104 (e.g., keypad, keyboard, touch screen, voice activated control technologies, or any other type of known input device).

In one aspect, client device 104 may store in memory one or more software applications that run on client devices 104 and 106 and are executed by the one or more processors. For instance, client device 104 may store software applications that, when executed by one or more processors, perform operations that allow user 110 (through client device 104) to interact with business entity 150 through, for example, a computing device, such as server 142 or other computing component(s) of system 140. In certain aspects, additional software applications may, when executed by client device 104, cause client device 104 to send information to be stored in a memory remote to client device 104 and/or receive information stored in a memory remote to client device 104 (e.g., memory associated with server 142, such as data repository 144). The disclosed embodiments are, however, not limited to such exemplary configurations, and in further embodiments, client devices 104 and 106 may be configured in any additional or alternate manner to enable communication and data exchange with system 140 across network 120.

Business entity 150 may, for example, be any type of business entity that may provide financial account(s) to one or more users (e.g., customers of business entity 150). For example, business entity 150 may be a financial institution, such as a commercial bank, an investment bank, a provider of a payment instrument or financial service accounts, etc. In some embodiments, a financial service account may be a checking, savings, credit, debit, prepay, and/or a reward or loyalty account, and a payment instrument may include, but is not limited to, a personal or corporate credit card, a debit card, a prepaid credit or debit card, or a check instrument.

Systems 140 and 182 may be a computing system configured to execute software instructions to perform one or more operations consistent with disclosed embodiments. In one aspect, system 140 may be associated with business entity 150, e.g., a financial institution, and system 182 may be associated with a third-party entity 192, such as issuer of a financial product (e.g., a credit card or a loyalty product). Systems 140 and 182 may be a distributed system that may include computing components distributed across one or more networks, such as network 120, or other networks.

In one aspect, systems 140 and 182 may include computing components known to those skilled in the art and configured to store, maintain, and generate data and software instructions. For example, system 140 (and further, system 182) may include one or more servers (e.g., server 142) and tangible, non-transitory memory devices (e.g., data repository 144). Server 142 may include one or more computing devices (e.g., servers) that may be configured to execute software instructions to perform one or more processes consistent with the disclosed embodiments. In one example, server 142 may be a computing device that executes software instructions that perform operations that provides information to one or more other components of computing environment 100. In one embodiment, server 142 may include a general purpose computer (e.g., a personal computer, network computer, server, or mainframe computer) having one or more processors that may be selectively activated or reconfigured by a computer program. In one aspect, server 142 (or other computing components of system 140) may be configured to provide one or more websites, digital portals, etc., that provide services consistent with business entity 150, such as an digital banking portal, and services consistent with disclosed embodiments. For instance, server 142 may be configured to provide information associated with a requested web page over communications network 120 to client devices 104 and 106, which may render the received information and present content from the web page on a display device. Additionally, server 142 may be incorporated as a corresponding node in a distributed network, and additionally or alternatively, as a corresponding networked server in a cloud-computing environment. Furthermore, server 142 may communicate via network 120 with one or more additional servers (not shown), which may facilitate the distribution of processes for parallel execution by the additional servers.

Data repository 144 may include one or more memories that are configured to store and provide access to data and/or software instructions. Such memories may include tangible non-transitory computer-readable media that store software instructions that, when executed by one or more processors (e.g., of server 132), perform one or more operations consistent with disclosed embodiments. Data repository 144 may also be configured to store information relating to business entity 150. In certain aspects, data repository 144 may be configured to store data identifying one or more customers of business entity 150 (e.g., customer profile data), financial account data associated with the customers (e.g., account data), data identifying transactions involving one or more customers of business entity 150 (e.g., transaction data), data derived from governmental or approved forms of authenticating identification (e.g., KYC credential data). Data repository 144 may also be configured to store one or more mobile wallet applications (e.g., mobile “apps”) that, as described below, may be provided in response to requests from client devices 104 and 106.

Cloud-based data repository 170 may include one or more physical data storage units (e.g., tangible non-transitory computer-readable media) disposed across multiple computing systems and servers. In some aspects, system 140, and additionally or alternatively, client devices 104 and 106, may be configured to access cloud-based data repository 170 through a corresponding API across network 120 using any of the communications protocols outlined above.

In certain embodiments, cloud-based data repository 170 may be configured to store one or more pre-loaded, encrypted mobile wallet tokens and corresponding private key values. By way of example, and as described below, the pre-loaded, encrypted mobile wallet tokens may be generated by system 140 using the exemplary processes described below, and may be delivered to client devices 104 and 106. In other aspects, cloud-based data repository 170 may be configured to store information relating to business entity 150, which includes, but is not limited to, customer profile data, account data, transaction data, and know-your-client (KYC) authentication data.

Data repositories 180 may include one or more data storages (e.g., tangible non-transitory computer-readable media) that store information associated with one or more third-party data providers 190. In some aspects, system 140 may be configured to request and obtain stored information through a corresponding application programming interface (API) using any of the communications protocols outlined above. In some aspects, third-party data providers 190 may include, but are not limited to, local state, and Federal government entities, airlines, rail carriers, electronic retailers, credit reporting agencies, issuers of credit cards, issuers of rewards or loyalty cards, and any additional or alternate provider of data relevant to users 110 and 112. In some instances, data repository 190 may store data that includes, but is not limited to, information identifying government-issued identifiers of users 110 and 112 (e.g., a driver's license, passport data, visa information), information identifying one or more financial products held by users 110 and 112, information identifying financial services transactions initiated by users 110 and 112, credit report data associated with users 110 and 112, information identifying travel documents of users 110 and 112, and/or information identifying credit cards, debit cards, prepaid credit or debit cards, and loyalty or reward cards held by users 110 and 112 and/or of potential interest to users 110 and 112.

Although computing environment 100 is illustrated in FIG. 1 with client devices 104 and 106 in communication with systems 140 and 182, data repositories 180, and could-based data repository 170, persons of ordinary skill in the art will recognize that environment 100 may include any number of number of mobile or stationary client devices 104 and 106, and any additional number of computers, systems, or servers without departing from the spirit or scope of the disclosed embodiments. Further, although computing environment 100 is illustrated in FIG. 1 with a single business entity 150 and/or system 140, and a single could-based data repository 170, persons of ordinary skill in the art will recognize that environment 100 may include any number of additional number of business entities and corresponding systems, any additional number of additional data repositories, any number of additional servers and data repositories, and any additional number of computers, systems, servers, or server farms without departing from the spirit or scope of the disclosed embodiments.

Communications network 120 may include one or more communication networks or medium of digital data communication. Examples of communication network 120 include a local area network (“LAN”), a wireless LAN, a RF network, a Near Field Communication (NFC) network, (e.g., a “WiFi” network), a wireless Metropolitan Area Network (MAN) connecting multiple wireless LANs, NFC communication link(s), and a wide area network (“WAN”), e.g., the Internet. Consistent with embodiments of the present disclosure, communications network 120 may include the Internet and any publicly accessible network or networks interconnected via one or more communication protocols, including, but not limited to, hypertext transfer protocol (HTTP) and transmission control protocol/internet protocol (TCP/IP). Communications protocols consistent with the disclosed embodiments also include protocols facilitating data transfer using radio frequency identification (RFID) communications and/or NFC. Moreover, communications network 120 may also include one or more mobile device networks, such as a GSM network or a PCS network, allowing client devices 104 and 106 to send and receive data via applicable communications protocols, including those described herein.

The disclosed embodiments include systems and methods that generate a mobile payment product, such as a mobile wallet, that is “pre-loaded” with one or more financial products available to a user (e.g., user 110) and eligible for inclusion within the mobile wallet. In some aspects, a computing system associated with a financial institution (e.g., system 140) may encapsulate information identifying the one or more available and eligible financial products into a corresponding data package (e.g., a “mobile wallet token”), which may be linked to user 110 and/or client device 102, encrypted, and stored in a data repository accessible to system 140 (e.g., cloud-based data repository 170).

In some embodiments, system 140 may be configured to identify the available and eligible financial products based on profile data associated with user 110 (e.g., customer profile data stored in data repository 144), data associated with financial service transactions initiated by user 110 (e.g., transaction data stored in data repository 144), and/or data identifying one or more accounts held by user 110 at the financial institution (e.g., account data stored in data repository 144. In other embodiments, system 140 may be configured to obtain the customer profile, transaction, and/or account data from one or more third-party data providers (e.g., from data repositories 180 of third-party data providers 190). In some aspects, the third-party data providers may be associated with an entity of a local, state, or Federal government, and additionally or alternatively, other business entities, such as those that issue financial products or provide credit reporting services.

In certain aspects, system 140 may also be configured to provide client device 104 with an application program (e.g., a mobile “app”) that, upon execution by client device 104, establishes the mobile wallet on client device 104. Client device 104 may, during execution of the application program, present an interface to user 110 that enables user 110 to log into the application program by entering one or more authentication credentials into client device 104. In some embodiments, and in response to a successful authentication of user 110, system 140 may be configured to retrieve the mobile wallet token from cloud-based data repository 170 and transmit the retrieved mobile wallet token to client device 104. Client device 104 may, for example, process the received mobile wallet token to populate the mobile wallet with the one or more identified financial products, which may facilitate purchases of goods or services from one or more participating physical or electronic retailers.

Further, in other aspects, system 140 may be configured to monitor the stored customer profile, transaction, and/or account data to identify additional financial products available to user 110 and eligible for include in user 110's mobile wallet. By way of example, user 110 may process user 110's transaction data to determine (e.g., based on a bank identification number (BIN)) that user 110 purchased goods and services using a new Visa™ credit card not previously included within user 110's mobile wallet token. In some aspects, system 140 may execute software processes that store information identifying the new Visa™ credit card (e.g., that “flag” the new credit card). Upon detection of a subsequent login to the mobile wallet application by user 110, system 140 may execute software processes that encapsulate the stored information to form an updated mobile wallet token, which may be transmitted to client device 104.

Using the disclosed embodiments, system 140 may generate a mobile wallet token that, upon receipt and processing by client device 104, populates user 110's mobile wallet with one or more pre-loaded financial products. In some aspects, the automatic pre-loading of user 110's mobile wallet by system 140 may reduce a burden imposed on user 110 to identify and manually populate the mobile wallet with eligible financial products. Further, the population of the mobile wallet by system 140 may provide user 110 with an enhanced and more complete view of the available financial products that are eligible for use within the mobile wallet.

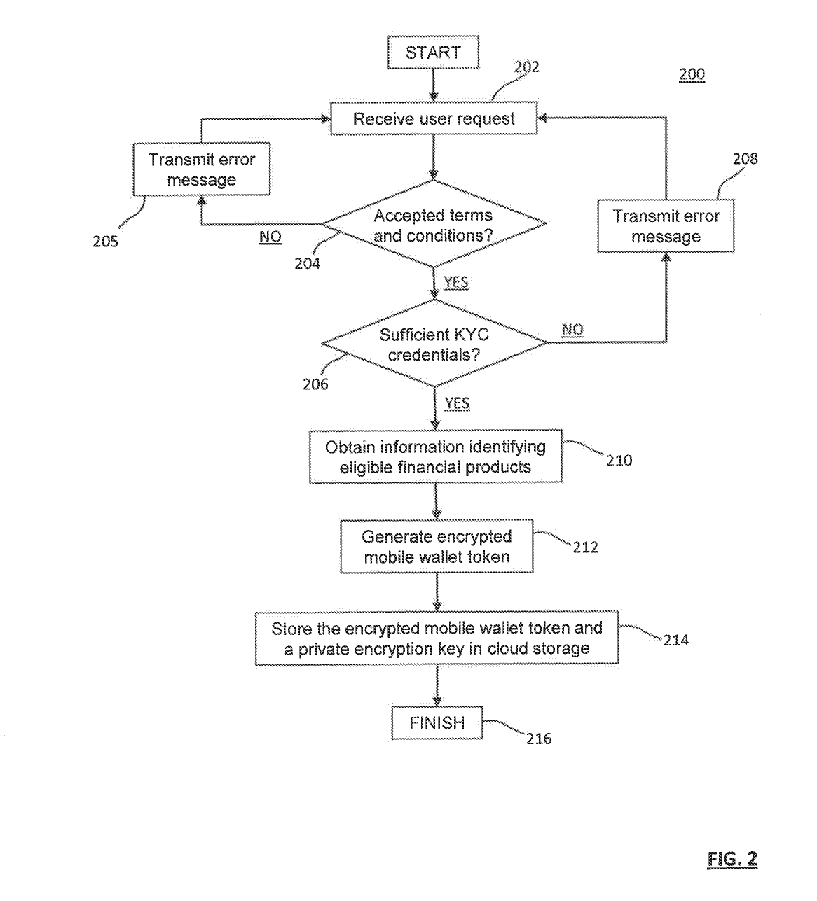

FIG. 2 illustrates an exemplary process 200 for loading a mobile wallet with eligible financial products available to a new or existing customer of a financial institution, in accordance with disclosed embodiments. In one embodiment, a system associated with the financial institution (e.g., system 140 associated with business entity 150) may be configured to receive a request from the new or existing customer (e.g., user 110) to register or enroll in a mobile wallet service provided by the financial institution. In response to the received request, system 140 may be configured to execute software instructions that identify one or more financial products associated with user 110 and eligible for inclusion in the requested mobile wallet, and to encapsulate information associated with the eligible financial products into a mobile wallet token for delivery to a device associated with user 110 (e.g., client device 104). In certain aspects, the disclosed embodiments may be configured to provide the mobile wallet token to client device 104 in response to an initial or subsequent attempt by user 110 to login to a mobile wallet application executing on client device 104, thus automatically populating the requested mobile wallet with the eligible financial products without input from user 110.

For example, user 110 may, via client device 104, access a web page associated with the financial institution that may be presented by client device 104. In one aspect, user 110 may be an existing customer of the financial institution, and may enter one or more authentication credentials (e.g., a user name, a password, an account number, and a personal identification number) into the accessed web page. In other aspects, user 110 may represent a new customer of the financial institution, and upon accessing the web page, user 110 may, via client device, register for digital banking with the financial institution, and may obtain authentication credentials that enable user 110 to access one or more digital banking services provided by the financial institution.

In certain embodiments, client device 104 may transmit the authentication credentials to system 140 over network 120, and system 140 may determine whether to grant user 110 access to one or more of the financial institution's digital banking services. By way of example, system 140 may compare the received authentication credentials against stored authentication credentials associated with one or more registered customers (e.g., as stored within data repository 144) to determine whether to grant user 110 access to the financial institution's web page (or other digital portal) and digital financial services.

In response to a successful authentication, system 140 may initiate an authenticated communications session with client device 104 and provide client device 104 with information identifying one or more digital banking services available to user 110, which client device 104 may process and render for presentation to user 110 within a corresponding web page or graphical user interface (GUI). By way of example, user 110 may, through client device 104, view a portion of the web page that describes a mobile wallet service provided by the financial institution (e.g., an advertisement for the mobile wallet service), and user 110 may click, tap, or otherwise select a region within the displayed web page to request access to the mobile wallet service. Client device 104 may, in response to user 110's selection, generate a request to enroll in and access the mobile wallet service, which may be transmitted to system 140 across network 120.

The disclosed embodiments are, however, not limited to authenticated communications sessions initiated by user 110 through a web page or graphical user interface (GUI) associated with the financial institution and presented by client device 104. In other instances, user 110 may access an instant messaging application (e.g., WhatApp™) executed by client device 104, which may enable user 110 to transmit an instant message to one or more representatives of the financial institution requesting access to the mobile wallet service. Further, user 110 may, in some instances, access a social networking application (e.g., Facebook™ or LinkedIn™) or microblogging application (e.g., Twitter™) through client device 104, and request access to the mobile wallet application through one or more messaging protocols appropriate to the social networking or microblogging application (e.g., by posting to a timeline associated with the financial institution, by attaching an appropriate hashtag or identifier to the posting, and/or through a messaging service native to the social networking application). In additional aspects, client device 104 may enable user 110 to request access to the mobile wallet service via text message (e.g., SMS text message), email message, or other form of electronic communication transmitted from client device 104 to system 140 across network 120.

Furthermore, the disclosed embodiments are not limited to requests for mobile wallet access generated by user 110 through self-service tools executed by client device 104 (e.g., web pages, GUIs, mobile applications, etc.). In some aspects, user 110 may visit a local branch of the financial institution, and may request access to the mobile wallet service from a representative of the financial institution at the local branch. In some instances, the representative may enter information identifying user 110 into an interface at a computing device or terminal disposed at the local branch, and a web tool or other application executed by the computing device or terminal may process the information to generate a request for the mobile wallet service, which may be transmitted to system 140 across network 120.

In other aspects, user 110 may request the mobile wallet service by contacting by a telephone call center associated with the financial institution. For example, user 110 may provide authenticating information (e.g., name, address, government-issued identifiers, etc.) to a representative of the financial institution at the call center, who may enter the information into an interface at a computing device or terminal disposed at the call center. In certain instances, a web tool or other application executed by the computing device or terminal may process the entered information to generate a request for the mobile wallet service, which may be transmitted to system 140 across network 120.

Referring to FIG. 2, system 140 may receive the request to enroll in or register for a mobile wallet service provided by the financial institution (e.g., in step 202). By way of example, system 140 may receive the request from client device 104 and additionally or alternatively, from a computing device or terminal disposed at a local branch or call center associated with the financial institution. The received request may, in some instances, include information identifying user 110, client device 104, and/or the computing device or terminal.

In response to the received request, system 140 may confirm user 110's acceptance of one or more terms and conditions of the mobile wallet service (e.g., in step 204). In some aspects, system 140 may tailor the terms and conditions of the mobile wallet service to a status of user 110 at the financial institution, e.g., system 140 may present terms and conditions to a new customer that differ from the terms and conditions presented to an existing customer.

By way of example, system 140 may generate and transmit information identifying one or more terms and conditions of the mobile wallet service to client device 104 for presentation to user 110. In an embodiment, client device 104 may receive the information, and in some instances, may present the terms and conditions to user 110 within the web page or GUI, and further, may prompt user 110 to input a response into client device 104 indicative an acceptance of the terms and conditions. Client device 104 may process and transmit, to system 140, user 110's response to the presented terms and conditions to server 140.

In other aspects, system 140 may transmit the information identifying the terms and conditions to the computing device or terminal disposed at the local branch or call center of the financial institution for presentation to user 110. In some instances, the computing device or terminal may present the terms and conditions to user 110 through a corresponding GUI (or audibly present the terms and conditions to user 110), and as described above, may prompt user 110 to provide a response to the computing device or terminal that indicates an acceptance of the terms and conditions. Additionally or alternatively, the representative of the financial institution (e.g., at the local branch or call center) may present the terms and conditions to user 110 and may provide the corresponding response to the computing device or terminal. In certain aspects, the computing device or terminal disposed at the local branch or call center may process and transmit user 110's response to the presented terms and conditions to server 140.

In step 204, system 140 may determine whether user 110 accepts the terms and conditions of the mobile wallet service. If system 140 finds that user 110 did not accept the terms and conditions of the mobile wallet service (e.g., step 204; NO), system 140 may be configured to generate an error message indicative of user 110's failure to accept the terms and conditions, which system 140 may transmit to client device 104 for presentation to user 110 (e.g., in step 205). Process 200 may then pass back to step 202, and in some aspects, system 140 may be configured to await receipt of additional requests to access the financial institution's mobile wallet service.

If, however, system 140 finds that user 110 accepted the terms and conditions of the mobile wallet service (e.g., step 204; YES), system 140 may determine whether sufficient documentation (e.g., know-your-client (KYC) credentials) exists to verify user 110's identity for enrollment in the mobile wallet service (e.g., in step 206). By way of example, KYC credentials consistent with the disclosed embodiments may include, but are not limited to, government-issued forms of identification (e.g., a driver's license, a passport, a social security card, an immigration status card, etc.), a birth certificate, a statement from a utility (e.g., an electric or water bill), documents issued by a state or Federal court, a legal document (e.g., a lease, title, or deed), and/or statements of account issued by one or more financial institutions.

In certain aspects, the financial institution associated with system 140 may establish a predetermined number and/or type of KYC credentials that are “sufficient” to verify user 110's identity, and the number and/or type of sufficient KYC credentials may be tailored to a status of user 110 at the financial institution. For example, system 140 may be configured to verify an identify of a new customer of the financial institution based on three different forms of KYC credentials, while an existing customer's identify may be verified based on a single government-issued form of identification. In some instances, system 140 may be configured to generate and store information identifying the predetermined number and/or type of KYC credentials that are sufficient to verify user 110's identity within a corresponding data repository (e.g., data repository 144).

In some embodiments, system 140 may be configured to obtain the information identifying the predetermined number and/or type of KYC credentials that are sufficient to verify user 110's identify, and in step 206, may determine whether user 110 is associated with the predetermined number and type of KYC credentials. By way of example, system 140 may be configured to access information (e.g., within data repository 140) that identifies one or more KYC credentials presented by user 110 in a prior authentication process at the financial institution. In other instances, the accessed information may specify that user 110 successfully obtained one or more financial services or products offered by the financial institution (and/or other financial institutions) that require KYC credentials similar to those sufficient for enrollment in the mobile wallet service. In certain aspects, system may be configured to compare the accessed information against the predetermined number and/or type of KYC credentials to verify user 110's identity in step 206.

In other embodiments, in step 206, system 140 may be configured to generate and transmit, to the computing device or terminal at the local branch or call center, a message requesting the representative of the financial institution to verify that user 110 possesses the predetermined number and/or type of KYC credentials deemed sufficient to verify user 110's identify for enrollment in the mobile wallet service. In some aspects, the financial institution representative may verify user 110's possession of the predetermined number and/or type of KYC credentials, and may provide input indicative of the verification (e.g., user 110 does or does not possess the specified KYC credentials) into the computing device or terminal, which may transmit the input to system 140 as a response to the message. System 140 may, for example, verify user 110's identity in step 206 based on the received response.

If system 140 fails to verify user 110's identity based on an insufficient number and/or type of previously or currently presented KYC credentials (e.g., step 206; NO), system 140 may be configured to generate an error message indicative of the failed verification, which system 140 may transmit to client device 104 for presentation to user 110 (e.g., in step 208). In some aspects, the error message may identify the predetermined type and/or number of KYC credentials that the financial institution deems sufficient to verify user 110's identity for the mobile wallet service, and additionally or alternatively, may identify those one or more types of KYC credentials that would enable system 140 to verify user 110's identity. Process 200 may then pass back to step 202, and in some aspects, system 140 may be configured to await receipt of additional requests to access the financial institution's mobile wallet service.

If, however, system 140 were to verify user 110's identify based on user 110's submission of the specified number and/or type of KYC credentials (e.g., step 206; YES), system 140 may execute software instructions that obtain information identifying one or more financial products eligible for inclusion into a mobile wallet (e.g., in step 210). In some embodiments, even if user 110 previously authenticated his or her identity with system 140, system 140 may require additional authentication steps prior to obtaining the eligible financial product information in step 210.

By way of example, an eligible financial product may be held by or associated with user 110, and may include, but is not limited to, a credit card, a debit card, a pre-paid credit or debit card, a reward and/or loyalty card, and additional or alternate financial instrument or payment product with which user 110 may initiate a financial services transaction involving a business entity (e.g., a physical or electronic retailer). In certain aspects, at least one of the eligible financial products may be issued by the financial institution associated with system 140. In other aspects, at least one of the eligible financial products may be issued by a business entity separate from the financial institution, e.g., an additional financial institution and/or a retailer.

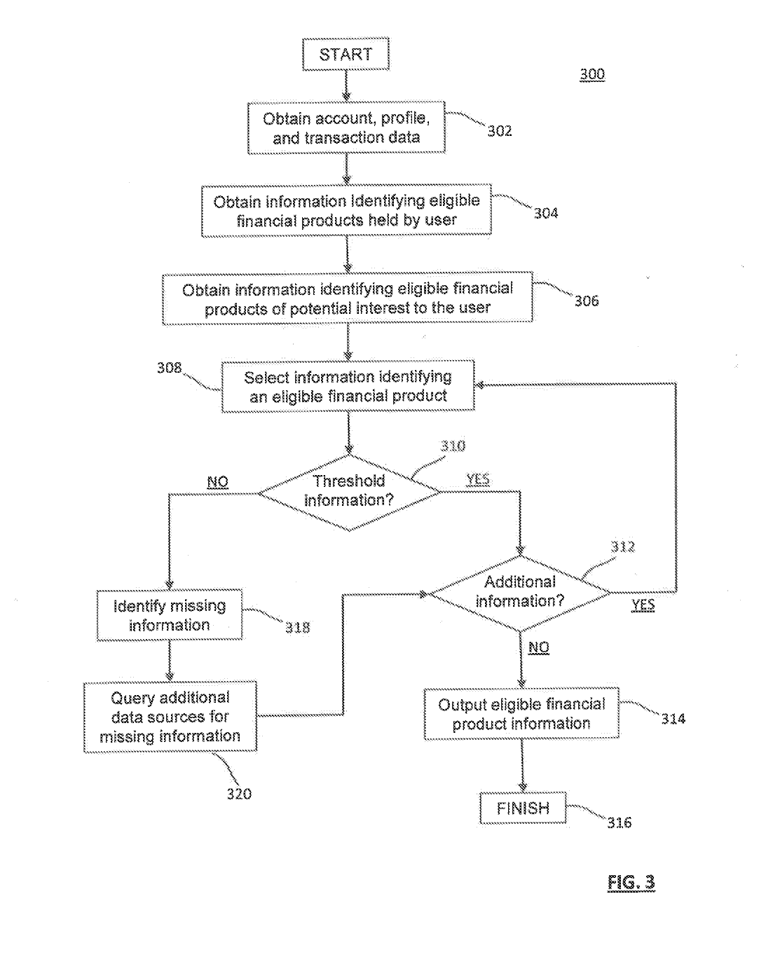

Further, as described below in reference to FIG. 3, system 140 may be configured to obtain the eligible financial product information from customer account, profile, and transaction data obtained one or more data repositories local accessible to system 140, and additionally or alternatively, obtained from one or more data repositories 180 associated with third-party data providers 190 and accessible to system 140 over network 120. In other aspects, described below in reference to FIG. 3, system 140 may also be configured to supplement the information obtained for a particular financial product (e.g., a credit card issued by a financial institution different from financial institution 150) with additional data obtained from one or more of third-party data providers 190 (e.g., a governmental database, a credit reporting agency, and/or an issuer of the financial product).

FIG. 3 illustrates an exemplary process 300 for identifying financial products eligible for inclusion in a mobile wallet, in accordance with disclosed embodiments. In one embodiment, a system associated with the financial institution (e.g., system 140 associated with business entity 150) may be configured to obtain account, profile, and/or transaction data associated with a customer requesting access to a mobile wallet service (e.g., user 110). System 140 may, in some aspects, execute software instructions to process the obtained data and extract information associated with one or more eligible financial products held by user 110, and additionally or alternatively, one or more eligible financial products that may be of potential interest to user 110. By way of example, an eligible financial product may include, but is not limited to, a credit card, a debit card, a pre-paid credit or debit card, a reward and/or loyalty card, and additional or alternate financial instrument or payment product with which user 110 may initiate a financial services transaction involving a business entity (e.g., a physical or electronic retailer). Further, in some aspects, system 140 may be configured to supplement the extracted financial product information with data obtained from systems associated with one or more third-party data providers, such as governmental entities, credit reporting agencies, and/or business entities that issue the financial products (e.g., data repositories 180 associated with third-party data providers 190).

In FIG. 3, system 140 may execute software instructions that obtain account data, profile data, and/or transaction data associated with user 110 (e.g., in step 302). By way of example, system 140 may be configured to obtain one or more of the account data, user profile data, and transaction data from a locally accessible data repository (e.g., account data, user profile data, and/or transaction data stored within data repository 144 and/or cloud-based data repository 170). Further, and as outlined above, the obtained account data may include one or more data records identifying financial products and/or financial service accounts issued by the financial institution and held by customers of the financial institution. In some instances, the customer profile data may include information (e.g., full names, mailing and/or billing addresses, government-issued identifiers (e.g., social security numbers, driver's license numbers, etc.), and/or account numbers) provided by customers during registration for digital baking services provided by the financial institution.

The obtained transaction data may, for example, include one or more data records identifying financial services transactions involving financial products held by user 110 and/or financial services accounts held by user 110. For example, the transaction data records may identify purchases of goods or services from electronic or physical retailers initiated by user 110 and involving a financial product held by user 110 (e.g., a credit card, a debit card, etc.). In some aspects, the transaction data records for purchase transactions may include information identifying the financial product (e.g., account numbers, expiration dates, bank identification numbers (BINs) of an issuing financial institution, and/or card security codes), as well as information identifying a corresponding card holder (e.g., a card holder name, a billing address, and/or a shipping address used to deliver purchased goods).

In other instances, the transaction data records may identify corresponding financial services transactions (e.g., electronic funds transfer (EFT) transactions) between financial services accounts of user 110. For example, the transaction data records may identify payments executed and/or scheduled by user 110 between a source account held by user 110 at the financial instruction (e.g., a checking or savings account) and one or more destination accounts associated with a third party (e.g., account linked to a credit card issued by another financial institution, an account linked to a gym membership, an account linked to a financial institution servicing a mortgage, etc.). The data records may include, for the initiated or scheduled transactions, information identifying the source account, information identifying the destination account, a BIN identifying a financial institution associated with the destination account.

In certain aspects, the initiated or scheduled transactions may include a “push” transaction in which user 110, via client device 104, configures system 140 to perform an EFT transaction from a checking of savings account held at the financial institution to a corresponding destination account associated with a third party (e.g., a credit card issuer, etc.). For example, user 110 may, through a web page or other digital portal of the financial institution displayed by client device 104, request that system 140 initiate and execute a transfer of funds between a source checking account at the financial institution and a destination account of a credit card issuer (e.g., in satisfaction of an outstanding credit card bill). In some aspects, the transaction data records may identify transaction details (e.g., date, time, amount) and information identifying the source and destination accounts (e.g., account numbers, BINs identifying the source and destination financial institutions, bank routing numbers, card expiration dates, card security codes, and information identifying the source and destination account holders).

In other aspects, the initiated or scheduled transactions may include a “pull” transaction in which user 110, via client device 104, configures a system associated with a third party to electronically transfer funds from a financial services account held by user 110 at the financial institution (e.g., a checking or savings account) to a destination account at a specified day and time. By way of example, user 110 may, via client device 104, access a web page or other digital portal provided by a system of a credit card issuer, and may initiate a transaction that transfers specified funds from user 110's checking account in satisfaction of an outstanding credit card bill. In some instances, the data record associated with a “pull” transaction may identify the source financial services account (e.g., user 110's checking account) and transaction details (e.g., date, time, and amount), but may include limited information associated with the destination account (e.g., a portion of the destination account number and/or a BIN of the credit card issuer).

Referring back to FIG. 3, in step 304, system 140 may execute software instructions that process the obtained account data, user profile data, and/or transaction data to identifying one or more eligible financial products held by user 110 (e.g., a financial product held in user 110's name). For example, system 140 may be configured to compare an identifier of user 110 (e.g., an identification number, user name, etc.) against data records of the obtained account and user profile data to identify at least one of the eligible financial accounts held by user 110. Further, in some aspects, system 140 may also be configured in step 304 to obtain account data associated with the identified financial products (e.g., a bank identification number (BIN) of the financial institution, an account number, an expiration date, and/or a card security code), and additionally or alternatively, data linking user 110 and the identified financial product (e.g., a billing address associated with the identified financial product).

Further, in step 304, system 140 may process the obtained transaction data records to identify at least one of the eligible financial products held by user 110. In some aspects, system 140 may execute software instructions that parse the transaction data records to identify purchase transactions involving accounts linked to a BIN of the financial institution. System 140 may, in some embodiments, determine that the accounts linked to the BIN of the financial institution corresponding to eligible financial products, and system 140 may be configured to extract information identifying the eligible financial products from the transaction data records. By way of example, user 110 may request a mobile wallet provided by TD Bank™, and system 140 may parse the obtained transaction records to identify purchase transactions involving accounts linked to a BIN of TD Bank™. System 140 may, in some instances, determine that credit and/or debit cards issued by TD Bank™ and linked to the identified accounts are eligible for inclusion in user 110's mobile wallet, and system 140 may extract information from the transaction data records that identifies the credit and/or debit cards and facilitates the loading of the credit and/or debit cards into user 110's mobile wallet.

In other embodiments, in step 304, system 140 may identify one or more candidate financial products issued by third parties (e.g., credit cards issued by other financial institutions), and may process the transaction data records to identify transactions having BINs corresponding to the candidate financial products. When system 140 identifies a BIN corresponding to one of the candidate financial products within the transaction data records, system 140 may determine that the user 110 holds the corresponding candidate financial product, which may be eligible for inclusion in user 110's mobile wallet. In some aspects, system 140 may extract information from the transaction data records that identifies and facilitates the loading of the corresponding candidate financial product into user 110's mobile wallet.

By way of example, user 110 may request a mobile wallet provided by TD Bank™, and system 140 may identify, as candidate financial products, credit and debit cards issued by Wells Fargo™, credit cards issued by American Express™, and credit cards issued by Discover™. As described above, system 140 may be configured to search the obtained transaction data records for BINs corresponding to the Wells Fargo™, American Express™, and Discover™ cards, and by way of example, system 140 may identify a “pull” transaction in which systems associated with American Express™ transferred funds from user 110's checking account at TD Bank™ (e.g., to pay an outstanding bill). In some aspects, system 140 may determine that user 110 hold an American Express™ credit card linked to the account within the obtained transaction data records, and system 140 may extract information from the transaction data records that identifies and facilitates the loading of the American Express′IV credit card into user 110's mobile wallet.

Further, in step 306, system 140 may execute software instructions that process the obtained account data, user profile data, and/or transaction data to identify one or more prospective financial products that are not currently held by user 110, but that may be of potential interest to user 110 based on the obtained account data, user profile data, and/or transaction data. By way of example, system 140 may determine, based on an analysis of the obtained transaction data records, that user 110 makes regular purchases at a local pharmacy (e.g., a CVS™ disposed proximate to user 110's home) using a credit card issued by TD Bank™. In some instances, system 140 may have a business relationship with CVS™, and may determine that a loyalty card issued by CVS™ may be of interest to user 110 and may be eligible for inclusion in user 110's mobile wallet. In other instances, system 140 may be configured to determine, based on the obtained transaction data records, that user 110 regularly purchases airline tickets using a credit card issued by TD Bank™, and may identify an alternate credit card issued by TD Bank™ that provides enhanced rewards for airline purchases for inclusion in user 110's mobile wallet.

The disclosed embodiments are, however, not limited to processes that identify financial products held by user 110 and/or of potential interest to user 110 within locally stored account data, user profile data, and transaction data. In some aspects, system 140 may obtain at least one of the account data, user profile data, and transaction data in steps 304 and 306 from data repositories 180 associated with third-party data providers 190 (e.g., a governmental entity, a credit reporting agency, a business entity issuing financial products, etc.). For example, in steps 304 and 306, system 140 may be configured to process a credit report of user 110 issued by a credit reporting agency (e.g., Experian™, TransUnion™, and/or Equifax™) to identify one or more financial products that are eligible for inclusion in user 110's mobile wallet.

In some embodiments, system 140 may execute software instructions that analyze the eligible financial information and determine whether the eligible financial product information includes information sufficient to load the eligible financial products into user 110's mobile wallet. In certain aspects, a mobile wallet application that establishes and administers user 110's mobile wallet may require one or more elements of information (e.g., a “threshold” amount of information) to load fully a particular financial product into user 110's mobile wallet for use in purchase transactions. By way of example, the threshold amount of information may include, for a credit or debit card, an account number associated with the credit or debit card, an expiration date, a corresponding card security code, and a full name and billing address of the card holder. In other instances, the threshold amount of information for a rewards or loyalty card may include, but is not limited to, an account number associated with the rewards or loyalty card and a full name of the card holder.

In some embodiments, system 140 may identify a portion of the eligible financial product information associated with a corresponding one of the eligible financial products (e.g., in step 308), and may determine whether the identified eligible financial product information includes the threshold amount of information (e.g., in step 310). If system 140 were to determine that the identified eligible financial product information includes at least the threshold amount of information (e.g., step 310; YES), system 140 may execute software instructions that determine whether additional eligible financial product information (e.g., associated with other eligible financial products) requires threshold analysis (e.g., in step 312). If system 140 were to determine that additional eligible financial product information requires threshold analysis (e.g., step 312; YES), then process 300 may pass back to step 308 and system 140 may perform the threshold analysis for the additional eligible financial product information.

If, however, system 140 were to determine that no additional eligible financial product information requires threshold analysis (e.g., step 312; NO), system 140 may execute software processes that output the eligible financial product information (e.g., in step 314). In some embodiments, system 140 may execute software instructions that tokenize and encrypt the outputted information for delivery to client device 104, as described below. Process 300 is then complete in step 316.

If, however, system 140 were to determine that the identified eligible financial product information does not include the threshold amount of information (e.g., step 310; NO), system 140 may identify one or more elements of information missing from the identified eligible financial product information (e.g., in step 318). By way of example, system 140 may identify an American Express™ credit card as an eligible financial product based on an obtained transaction record corresponding to a “pull” transaction initiated by one or more systems associated with American Express™. The obtained transaction record may, for example, include an account number associated with the American Express™ credit card, but may not specifically identify the corresponding expiration date, the corresponding card security code, or the billing address of user 110. In some aspects, system 140 may identify the expiration date, the card security code, and the billing address as missing information in step 318.

In step 320, system 140 may be configured to query one more locally accessible data repositories (e.g., data repository 144 and/or cloud-based data repository 170), and additionally or alternatively, systems associated with one or more external data providers (e.g., data repositories 180 of third-party data providers 190) to obtain at least a portion of the missing information. By way of example, in step 320, system 140 may execute software instructions to obtain a billing address associated with the American Express™ credit card from user profile data stored locally within data repository 144 and/or cloud-based data repository 170. Additionally or alternatively, system 140 may execute software instructions that query databases provided by one or more local, state, or Federal governmental agencies. By way of example, the database query may be delivered to a system associated with the local, state, or Federal governmental agencies across network 120 through a corresponding application programming interface (API) using any of the communication protocols outlined above.

In other aspects, the financial institution associated with system 140 may establish business relationships with one or more third-part entities, such as an issuer of a credit or debit card, an issuer of a rewards or loyalty card, and/or a credit reporting agency, from which system 140 may be configured to request at least a portion of the missing information in step 320. By way of example, the financial institution may establish a business relationship with American Express™ that facilitates information sharing and a cross-platform marketing of products. In some instances, in step 320, system 140 may request at least a portion of the missing information from databases and data repositories maintained by systems associated with American Express™. In other, system 140 may query databases and other data repositories maintained by systems associated with a credit reporting agency (e.g., Experian™, Equifax™, and/or TransUnion™) in step 320 to obtain at least a portion of the missing information. By way of example, the requests for missing information may be delivered to the third-party data providers (e.g., data repositories 180 of third-party data providers 190) through a corresponding application programming interfaces (APIs) using any of the communication protocols outlined above.

In certain aspects, and upon querying one or more of the locally accessible data repositories and third-party data providers (e.g., in step 320), system 300 may pass back to step 312, and system 140 may determine whether the information eligible financial product information requires the threshold analysis, as described above.

Referring back to FIG. 2, system 140 may execute software instructions that process the obtained eligible financial product information to generate an encrypted mobile wallet token (e.g., in step 212). In some embodiments, in step 212, system 140 may format the obtained eligible financial product information in accordance with one or more requirements of a corresponding mobile wallet application provided by system 140, and may encrypt the formatted information using a public key value specific to user 110 and to client device 104.

In certain aspects, system 140 may be configured to encrypt the formatted information in step 212 using a previously generated public key value, which system 140 may obtain from a locally accessible data repository (e.g., data repository 144 or cloud-based data repository 170). In other aspects, however, system 140 may generate the public key value based, for example, information identifying user 110 (e.g., a user name or user identifier) and/or information identifying client device 104 (e.g., a MAC address, an IP address, an International Mobile Equipment Identification (IMEI) number, and/or a Mobile Equipment ID (MEID) number). The disclosed embodiments are not limited to the symmetric key encryption schemes described above, and in additional embodiments, system 140 may encrypt the formatted information using any additional or alternate encryption scheme appropriate to the mobile wallet application, system 140, and/or client device 104 (e.g., an asymmetric key encryption scheme).

In an embodiment, and as described above, the information associated with a particular eligible financial product (e.g., a credit card, a debit card, and/or a rewards or loyalty card) may include at least a threshold amount of information identifying the particular eligible financial product. In certain aspects, and upon decrypting and unpacking of the mobile wallet token, client device 104 may be configured to “fully” load the particular financial product into user 110's mobile wallet, and the fully loaded financial product may be ready for use by user 110 in purchase transactions of good and/or services.

In other aspects, the information associated with a particular eligible financial product may fail to include the threshold amount of information for the particular financial product. By way of example, system 140 may determine that a rewards or loyalty card associated with a particular retailer may be of interest to user 110 based on transaction data identifying one or more purchase transactions made by user 110 at the particular retailer. In some embodiments, in step 212, system 140 may execute software instructions to encapsulate information identifying the rewards or loyalty card within the mobile wallet token, along with additional information that, upon processing by client device 104, enables client device 104 to fully provision the rewards or loyalty card within user 110's mobile wallet.

For instance, the additional information may enable client device 104 to establish a communications session with a computing system and/or data repository associated with an issuer of the rewards or loyalty card (e.g., the particular retailer) and obtain financial product information that would enable client device 104 to fully provision the rewards or loyalty card in user 110's mobile wallet. In other instances, the additional information may include a flag that, upon processing by client device 104, causes client device 104 to present a message (e.g., within a corresponding interface of a mobile wallet application) prompting user 110 to input into client device 104 financial product information that would enable client device 104 to fully provision the rewards or loyalty card.

Referring back to FIG. 2, system 140 may execute software instructions to store the mobile wallet token and a private key of user 110 in a data repository for subsequent retrieval and transmission to client device 104 (e.g., in step 214). By way of example, system 140 may be configured to store the mobile wallet token and the private key in cloud-based storage (e.g., cloud-based data repository 170), and link the stored mobile wallet token and the public key to information identifying user 110 (e.g., a user name, user identifier, etc.) and/or information identifying client device 104 (e.g., a MAC address, an IP address, an IMEI number, and/or a MEID number). Upon successful cloud storage of the mobile wallet token and private encryption key in step 214, exemplary process 200 is then complete in step 216.

In certain embodiments, the stored mobile wallet token, and additionally or alternatively, the stored private encryption key, may be associated with corresponding periods of validity, and as such, may “expire” at some time subsequent to their generation by system 140 and storage within cloud-based data repository 170. By way of example, the stored mobile wallet token and/or the stored private encryption key may expire at a predetermined time after cloud-based storage (e.g., twelve hours, one day, one week, etc.), and the predetermined time may by established by system 140 or cloud-based data repository 170 in accordance with one or more rules of the financial institution. In other instances, system 140 or cloud-based data repository 170 may be configured to render invalid the stored mobile wallet token and/or the stored private encryption key in response to one or more events, such as a detection of fraudulent activity.

For instance, upon expiration of the stored mobile wallet token, system 140 may execute software instructions that process account data, user profile data, and/or transaction data associated with user 110 to obtain information identifying one or more additional financial products eligible for inclusion in user 110's mobile wallet, and currently held by user 110 and/or financial products of potential interest to user 110. In some aspects, and as described above, system 140 may execute software instructions that process the obtained information identifying the additional eligible financial products and generate an updated encrypted mobile wallet token, which may be stored within cloud-based data repository 170 for subsequent retrieval by client device 104, as described below. Further, in additional aspects, and upon expiration of the stored private encryption key, system 140 may be configured to generated a new version of the private encryption key (e.g., “refresh” the private encryption key) using any of the techniques outlined above.

As described above, client device 104 may be configured to execute a mobile wallet application (e.g., a mobile “app”) provided by a financial institution (e.g., business entity 150 associated with system 140). As described above, client device 104 may, upon execution of the mobile wallet application, obtain an encrypted mobile wallet token and corresponding private key stored within a cloud-based data repository (e.g., cloud-based data repository 170), decrypt and unpack the encrypted mobile wallet token to obtain information identifying one or more eligible financial products, and provision a mobile wallet associated with user 110 based on the obtained eligible financial product information, and additionally or alternatively, on information obtained from user 110 and/or information obtained from one or more third-party data providers (e.g., issuers of one or more credit cards, rewards cards, and/or loyalty cards).

In certain embodiments, and in response to the successful generation and cloud-based storage of a requested mobile wallet token using the exemplary processes outlined above, system 140 may execute software instructions to generate a message providing user 110 with instructions for obtaining the mobile wallet application (e.g., a mobile “app” provided by the financial institution), and to provide the generated message to client device 104 using one or more of the communications outlined above. By way of example, system 140 may be configured to access user profile data associated with user 110 (e.g., stored within data repository 144), and determine a mode of communication preferred by user 110. In some aspects, the preferred mode of communication may include electronic messaging using an email address specified in the user profile data, or a SMS or MMS text message transmitted to a specified mobile telephone number. System 140 may, for example, be configured to transmit the generated message across network 120 using the mode of communications preferred by user 110. In other aspects, however, system 140 may transmit the generate message to client device 102 across network 120 using any additional or alternate mode of communication appropriate to network 120, e.g., a default mode of communication specified by the financial institution.

Client device 104 may, for example, receive the message from system 140, and render the received message and present the instructions for obtaining the mobile wallet application to user 110. In some instances, the presented instructions may include a hyperlink that, upon selection by user 110, may enable user 110 to access a web page or other digital portal associated with the financial institution and initiate download and installation of the mobile wallet application on client device 104 (e.g., as provided by system 140). In other instances, the presented instructions may enable user 110 to access a web page or digital portal of an electronic retailer (e.g., an “app” store), which may enable user 110 to download and install the mobile wallet application on client device 104.

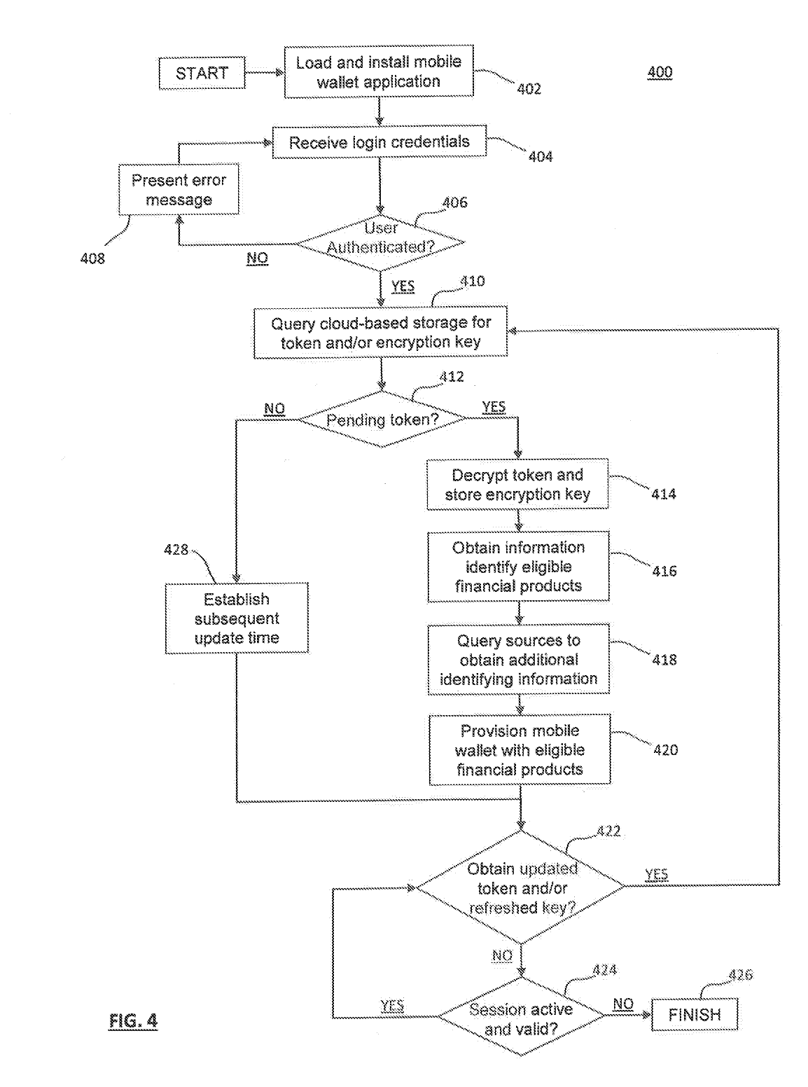

Further, in additional aspects, user 110 may, via client device 104 access the web page or digital portal associated with the financial institution or electronic retailer to initiate download and installation of the mobile wallet application on client device 104 prior to or absent presentation of the instructions (e.g., in response to an electronic advertisement). In other aspects, user 110 may represent an existing customer of the financial institution, and may thus have previously downloaded and installed the mobile wallet application on client device 104. Once downloaded, client device 104 may execute the mobile wallet application, which may establish the mobile wallet on client device 104, as described below in reference to FIG. 4.

FIG. 4 illustrates an exemplary process 400 for loading a mobile wallet with new or updated eligible financial products, in accordance with disclosed embodiments. In one embodiment, a device associated with a user (e.g., client device 104 of user 110) may execute a mobile wallet application (e.g., a mobile “app” provided by a financial institution) that, upon successful authentication of user 110, may query a cloud-based storage (e.g., cloud-based data repository 170) for an updated encrypted mobile wallet token and private encryption key associated with user 110 and/or client device 104. If cloud-based data repository 170 includes the encrypted mobile wallet token (and additionally or alternatively, a refreshed version of a corresponding encryption key), client device 104 may access updated encrypted mobile wallet token, and execute software instructions to decrypt and process the encrypted mobile wallet token to obtain information identifying one or more financial product eligible for inclusion within a mobile wallet of user 110. Client device 104 may, in some aspects, be configured to execute software instructions that provision user 110's mobile wallet based on the obtained eligible financial product information, and further, based on additional information input into client device 104 by user 110 and/or obtained from a third-party data provider (e.g., systems or data repositories associated with an issuer of an eligible financial product.

Referring to FIG. 4, client device 104 may be configured to execute software instructions that obtain and subsequently install the mobile wallet application on client device 104 (e.g., in step 402). In some aspects, user 110 may, via client device 104, access a web page or other digital portal associated with the financial institution and initiate download and installation of the mobile wallet application on client device 104 (e.g., as provided by system 140). In other instances, user 110 may, via client device 104, access a web page or digital portal of an electronic retailer (e.g., an “app” store), which may enable user 110 to download and install the mobile wallet application on client device 104.

In certain aspects, client device 104 may be configured to execute the installed mobile wallet application (e.g., in response to a request from user 110, and receive one or more login credentials associated with user 110 (e.g., in step 404). The login credentials may include, but are not limited to, a user name, a password, and/or an additional unique identifier associating the financial institution and user 110 (e.g., a PIN). Further, in some instances, client device 104 may be configured to present a login prompt or screen to user 110 within a graphical user interface (GUI) associated with the mobile wallet application, and the presented login prompt or screen may request that user 110 provide login credentials as input to client device 104.

Upon receipt of the login credentials, client device 104 may authenticate user 110 in step 406 by comparing the received login credentials against stored authentication information associated with one or more authenticated users (e.g., within data repository 144). If client device 104 fails to authenticate user 110 (e.g., step 406; NO), client device 104 may be configured to generate and present an error message to user 110 indicating the failed authentication (e.g., in step 408). By way of example, the message may specify that client device 104 failed to recognize a provided login credential, and additionally or alternatively, may provide a link enabling user 110 to obtain or reset an unknown login credential. Process 400 may then pass back to step 404, and in some aspects, client device 104 may be configured to await receipt of additional login credentials from user 110.

If, however, client device 104 were to authenticate user 110 (e.g., step 406; YES), client device 104 may query cloud-based storage (e.g., cloud-based data repository 170) to obtain a pending encrypted mobile wallet token and corresponding private encryption key (e.g., in step 410). By way of example, in step 410, client device 104 may transmit, to cloud-based data repository 170 across network 120, information identifying user 110 and additionally or alternatively, client device 104.

As described above, cloud-based data repository 170 may be configured to store a plurality of encrypted mobile wallet tokens associated with corresponding users of the mobile wallet service. By way of example, the stored mobile wallet tokens may be linked to information identifying a user (e.g., a user name, etc.) and information identifying a corresponding client device (e.g., an IP address, a MAC address, an MEID number, or an IMEI number). In some aspects, a computing system or server associated with cloud-based data repository 170 may receive the transmitted information and determine whether a corresponding one of the stored encrypted mobile wallet tokens is associated with user 110 and/or client device 104.

If cloud-based data repository 170 stores a pending encrypted mobile wallet token associated with user 110 and/or client device 104, the computing system or server may package the pending encrypted mobile wallet token and corresponding private encryption key as a response to the query, which may be transmitted to client device 104 across network 120. Alternatively, if cloud-based data repository 170 does not store a pending encrypted mobile wallet token associated with user 110 and/or client device 104, the computing system or server may transmit information indicating the lack of the pending encrypting mobile wallet token to client device 104 as the response to the query.

Referring back to FIG. 4, client device 104 may receive the response to the query from cloud-based data repository 170, and may be configured to execute software instructions that parse the received response to determine whether cloud-based data repository 170 includes a pending mobile wallet token associated with user 110 and/or client device 104 (e.g., in step 412). If the received response includes the pending mobile wallet token and the corresponding private encryption key (e.g., step 412; YES), client device 104 may be configured to store the private encryption key in a locally accessible storage device, and may decrypt the pending mobile wallet token using a combination of the received private encryption key and a corresponding public encryption key stored locally at client device 104 (e.g., in step 414).

In certain aspects, client device 104 may execute software instructions that process the decrypted mobile wallet token to obtain information identifying one or more financial products eligible for inclusion in a mobile wallet associated with user 110 and maintained at client device 104 (e.g., in step 416). In some instances, the eligible financial product information associated with a particular financial product (e.g., a credit card, a debit card, and/or a rewards or loyalty card) may include at least a predetermined amount of information (e.g., a threshold amount of information) enabling client device 104 to “fully” load the particular financial product into user 110's mobile wallet.

In other instances, however, the eligible financial product information associated with a particular financial product may include only a portion of the predetermined information enabling client device 104 to “fully” load the particular financial product into user 110's mobile wallet. In certain aspects, and in addition to the portion of the predetermined information, the eligible financial product information may also specify a source (e.g., a URL or IP address) of additional information that, when retrieved by client device 104, may enable client device 104 to “fully” load the particular financial product into user 110's mobile wallet. By way of the example, the source of the additional information may include, but is not limited to, user 110, the financial institution associated with system 140, and/or a third-party or business entity that issues of the particular financial instrument.

In some embodiments, client device 104 may be configured to execute software instructions that identify one or more sources of additional information within the obtained eligible financial product information, and that query the identified sources to obtain the additional information enabling client device 104 to fully load one or more of the eligible financial products into user 110's mobile wallet (e.g., in step 418). By way of example, client device 104 may determine the obtained information associated with an eligible credit card includes a full cardholder name and account number, but fails to include an expiration date and a card security code that would enable client device 104 to fully load the eligible credit card into user 110's mobile wallet. In some aspects, in step 418, client device 104 may be configured to parse the obtained information to identify a source for the missing expiration date and card security code (e.g., an IP address of a server or data repository associated with an issuer of the credit card), and may obtain the missing expiration date and card security code from the issuer server or data repository across network 120.

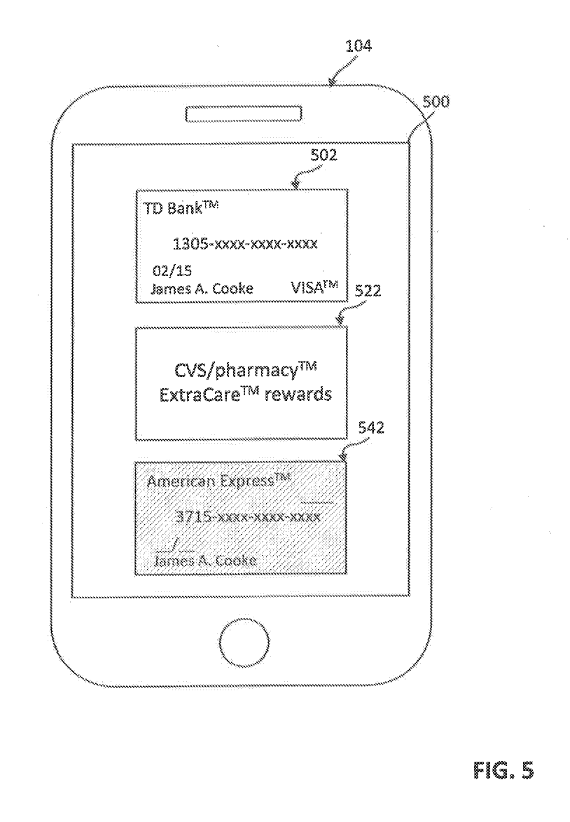

Client device 104 may, in some embodiments, be configured to process the information identifying the eligible financial products (e.g., as obtained from the mobile wallet token) and the additional information (e.g., as obtained from the identified sources) to provision user 110's mobile wallet with the one or more eligible financial products (e.g., in step 420). In some aspects, and based on the information obtained from the mobile wallet token and the additional information obtained from the identified sources, client device 104 may be configured to “fully” load one or more financial products into user 110's mobile wallet, and the fully loaded financial products may be ready for use by user 110 in purchase transactions of goods and/or services. Alternatively, if client device 104 were unable to fully load a particular financial product based on the information obtained from the mobile wallet token and the identified sources, client device 104 may be configured to perform a partial load of the particular financial product into user 110's mobile wallet based on the available information. Further, in some instances, client device 104 may be configured to present indications of the fully and partially loaded financial products within a graphical user interface (GUI) of mobile wallet application, as described below in reference to FIG. 5.

FIG. 5 illustrates an exemplary interface 500 for a mobile wallet application, in accordance with disclosed embodiments. In one embodiment, and as described above, client device 104 may be configured to decrypt and unpack a received mobile wallet token, further, to display within interface 500 indicators (e.g., indicators 502, 522, and 542) corresponding to financial products included within the received mobile wallet token.

In some embodiments, and as described above, the received mobile wallet token may include at least a threshold amount of information identifying a particular financial product (e.g., a credit card, a debit card, and/or a rewards or loyalty card). By way of example, upon decrypting and unpacking of the mobile wallet token, client device 104 may be configured to “fully” load the particular financial product into user 110's mobile wallet, and the fully loaded financial product may be ready for use by user 110 in one or more purchase transactions of good and/or services.

Referring to FIG. 5, interface 500 may present indicators 502 and 522 that are representative of financial products fully loaded into user 110's mobile wallet and capable of being utilized by user 110 for purchases of goods and/or services. By way of example, indicator 502 represents a Visa™ credit card issued by TD Bank™ and held in the name of user 110. Further, in some instances, the information loaded by client device 104 from the mobile wallet token into the mobile wallet application includes at least the threshold amount of information, e.g., the account number associated with the Visa™ credit card, the expiration date (e.g., “September 2015”), a corresponding card security code (not depicted), and a full name and billing address of the card holder (e.g., “James A. Cooke”).

Further, as illustrated in FIG. 5, indicator 522 represents an ExtraCare™ rewards card issued by CVS/Pharmacy™ and provided to user 110. In some instances, user 110 may present the ExtraCare™ rewards card prior to purchasing goods from CVS/Pharmacy™ to obtain preferential discounts, and further, accrue points that may result in additional discounts. Although not depicted in FIG. 5, the information loaded by client device 104 from the mobile wallet token into the mobile wallet application includes at least the threshold amount of information for the ExtraCare™ rewards card, an account number associated with the rewards or loyalty card and a full name of the card holder.

In other embodiments, the received mobile wallet token may fail to include the threshold amount of information identifying a particular financial product (e.g., a credit card, a debit card, and/or a rewards or loyalty card) held by user 110, and additionally or alternatively, of potential interest to user 110. For example, and as described above system 140, may determine that user 110 holds an American Express™ credit card, based on transaction data records identifying a “pull” transaction in which a computer system associated with American Express™ initiates a funds transfer from a checking account of user 110. In certain aspects, as system 140 may determine, from the transaction data records and/or a third party data provider, an account number of the American Express™ credit card and a cardholder. System 140 may, however, be unable to identify the expiration date, the corresponding card security code, or the billing address of the card holder. Thus, in some instances, the information identifying the American Express™ credit card within the mobile wallet token may be “missing” information that would otherwise enable client device 104 to fully load the American Express™ credit card into user 110's mobile wallet.

In certain aspects, when the mobile wallet token fails to include the threshold amount of information for a corresponding financial product, and client device 104 is unable to obtain the missing information from one or more corresponding sources, client device 104 may be configured to perform a partial load of the corresponding financial product into user 110's mobile wallet. Further, in some instances, client device 104 may be configured to visually distinguish the displayed indicator of a partially loaded financial product from other fully loaded financial products (e.g., by shading the indicator, outlining the indicator with dashed or bold lines, changing a color of the indicator, or through any additional or alternate visual effect that distinguishes the partially loaded indicator from fully loaded indicator).

For example, as illustrated in FIG. 5, client device 104 may be configured to partially load the American Express™ credit card into user 110's mobile wallet, and to generate shaded indicator 542 that distinguishes the partially loaded American Express™ credit card from the fully loaded TD Bank™ Visa™ credit card and the ExtraCare™ rewards card. Further, in certain aspects, user 110 may be able to tap, click on, or otherwise select a portion of indicator 542 to input, into client device 104, the missing expiration date, corresponding card security code, and billing address to complete the loading of the American Express™ credit card into user 110's mobile wallet and render the American Express™ credit card usable for purchases vide the mobile wallet.

Referring back to FIG. 4, and subsequent to provisioning user 110's mobile wallet, client device 104 may be configured to determine whether cloud-based data repository 170 should be queried to obtain an updated mobile wallet token, and additionally or alternatively, a refreshed private encryption key (e.g., in step 422). In some aspects, client device 104 may be configured to query cloud-based data repository 170 for an updated mobile wallet token and/or a refreshed private encryption key at one or more pre-determined intervals established in conjunction with system 140 (e.g., every hour, two hours, twelve hours, or twenty-four hours), and additionally or alternatively, at intervals specified by user 110. Further, by way of example, the intervals may be established by the financial institution associated with system 140 to coincide with a conclusion of a period of validity associated with the mobile wallet tokens (e.g., an “expiration” of the mobile wallet tokens) stored in cloud-based data repository 170 and a time at which system 140 may generate updated mobile wallet tokens to replace the expired and stored mobile wallet tokens.

If client device 104 were to determine that cloud-based data repository 170 should be queried (e.g., step 422; YES), exemplary process 400 may pass back to step 410, and client device 104 may be configured to obtain the updated encrypted mobile wallet token and/or refreshed encryption key from cloud-based data repository 170) and provision user 110's mobile wallet using the techniques described above.

If, however, client device 104 were to determine that cloud-based data repository 170 should not be queried (e.g., step 422; NO), client device 104 may determine whether user 110's authenticated session of the mobile wallet application remains active and valid (e.g., in step 424). By way of example, client device 104 may render an authenticated session of the mobile wallet application inactive and invalid after expiration of a predetermine time period subsequent to an initial login and authentication of user 110, and additionally or alternatively, subsequent to user 110's last interaction with the mobile wallet application.

If client device 104 were to determine the authenticated mobile wallet application session to be active and valid (e.g., step 424; YES), exemplary process 400 may pass back to step 422, and client device 104 may determine whether to query cloud-based data repository for an updated mobile wallet token or refreshed private encryption key, as described above. Alternatively, if client device 104 were to determine the authenticated mobile wallet application session to be inactive and invalid (e.g., step 424; NO), then exemplary process 400 is complete in step 426.

Further, referring back to step 412, if cloud-based data repository 170 is determined not to include the pending mobile wallet token (e.g., step 412; NO), client device 104 may be configured to identify a subsequent time at which client device 104 should query cloud-based data repository 170 for an updated mobile wallet token or a refreshed private encryption key (e.g., in step 428). For example, in step 432, client device 104 may obtain a previously established time from a locally accessible storage device, and additionally or alternatively, may establish a time to query cloud-based data repository 170 based on one or more preferences of user 110 and/or requirements of system 140. In certain aspects, upon identification of the subsequent time, process 400 may pass forward to step 422, and client device 104 may determine whether cloud-based data repository 170 should be queried for an updated mobile wallet token and/or a refreshed private encryption key, as described above.

The disclosed embodiments obtain information identifying one or more financial products, such as credit card, debit cards, and rewards or loyalty cards, that are held by user 110 and/or of potential interest to user 110, and encapsulate the obtained information into a mobile wallet token, which may be unpacked by client device 104 and loaded into user 110's mobile wallet. The disclosed embodiments are, however, not limited to such exemplary financial products, and in other instances, system 140 may obtain information associated user 110 from various local, state, and Federal governmental entities (e.g., from data repositories 180 of third-party data providers 190). Using the exemplary processes described above, system 140 may, for example, process the obtained information to identifying not financial products, but governmental-issued forms of identified associated with user 110 (e.g., a driver's license, a visa, and/or a passport), which may be encapsulated into a mobile wallet token and transmitted to client device 104, and presented to user 110 through an interface of the mobile wallet application.

In other aspects, system 140 may obtain information associated user 110 from computing systems of one or more airlines (e.g., United™ and/or Air Canada™) and rail carriers (e.g., Amtrak™ Using the exemplary processes described above, system 140 may, for example, process the obtained information to identify documents and/or tickets associated with future travel, which system 140 may be encapsulated into a mobile wallet token and transmitted to client device 104, and presented to user 110 through an interface of the mobile wallet application. In further embodiments, system 140 may be configured to identify an encapsulate into a mobile wallet token any additional or alternate financial products, government-issued forms of identification, travel documents, and other information appropriate for presentation through an interface associated with a mobile wallet application executed by client device 104.

In some aspects, the disclosed embodiments enable system 140 to analyze transaction data associated with user 110, and to identify financial products held by user 110 and/or or potential interest to user 110. As described above, system 140 may execute software instructions that encapsulate information specifying the identified financial products into a mobile wallet token, which may be encrypted and transmitted across network 120 to client device 104. Client device 104 may, for instance, receive, decrypt, and unpack the “pre-loaded” mobile wallet token to establish the identified financial products in user 110's mobile wallet for use in subsequent purchase transactions.

The pre-loaded financial products may include payment products, such as credit cards, debit cards, and pre-paid credit or debit cards. In other aspects, and as described above, financial products consistent with the disclosed embodiments may include one or more loyalty cards issued by a retailer or other business entity (e.g., an issuer), and when used in conjunction with a purchase from a participating retailer (e.g., a transactional entity), may accrue rewards that user 110 may redeem at the participating retailer or at other retailers (e.g., a Starbucks™ card that provides user 110 with redeemable rewards when used in conjunction with purchases of food and beverage). The loyalty cards may, in some instances, be eligible for inclusion within user 110's mobile wallet, and further, may be used in conjunction with financial products loaded into user 110's mobile wallet to a execute a purchase transaction at a participating retailer or business entity using a corresponding mobile payment protocol.

In some embodiments, user 110 may provide, through client device 104, information that identifies one or more loyalty cards, e.g., through an initial registration of user 110 for digital banking and/or mobile wallet services provided by a financial institution associated with system 140. In certain aspects, system 140 may be configured to store the provided information within a locally accessible data repository (e.g., within account and/or profile data stored in data repository 144), and further may be configured to implement one or more of the exemplary processes outlined above to encapsulate information associated with the user-identified loyalty cards within a mobile wallet token for presentation to client device 104.

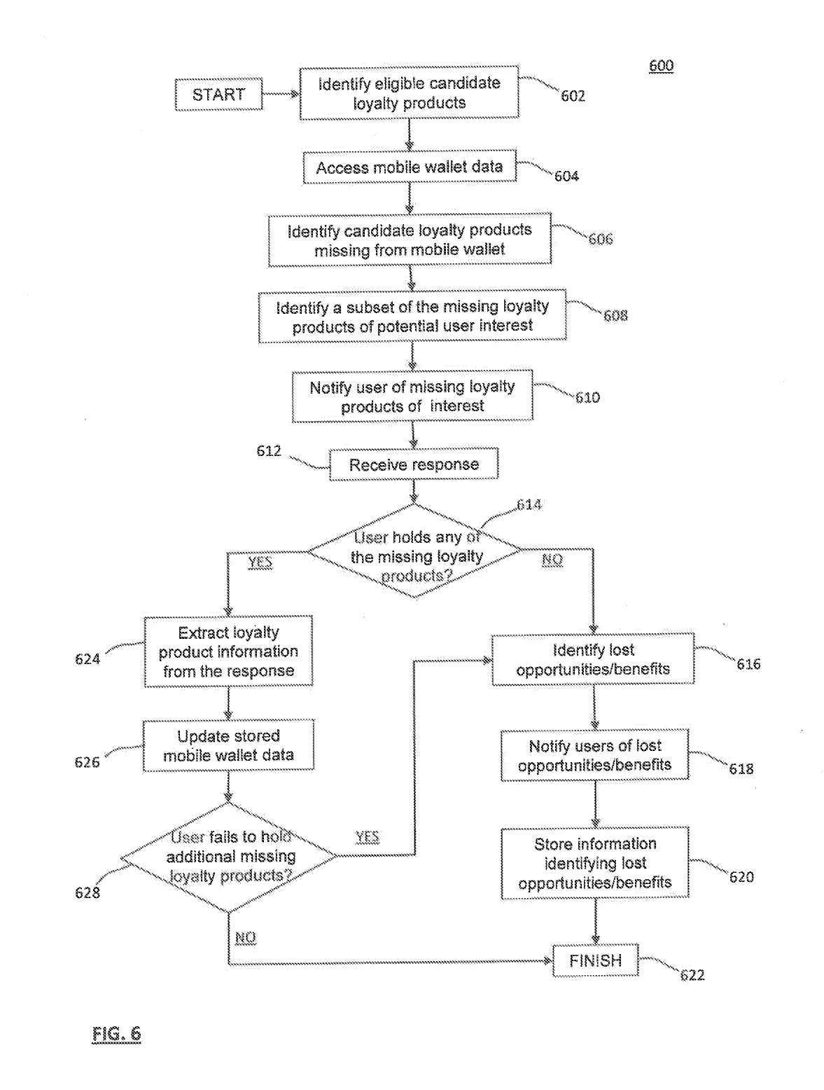

In other embodiments, system 140 may execute software instructions that identify one or more loyalty cards eligible for inclusion in user 110's mobile wallet based on, among other things, patterns of purchase transactions involving user 110 and one or more retailers and/or other business entities. By way of example, system 140 may identify eligible loyalty cards missing from user 110's mobile wallet (e.g., as established by a mobile wallet application executed by client device 104), and may further determine that at least a portion of the missing eligible loyalty cards are relevant to user 110's prior purchase transactions, and as such may be of potential interest to user 110. As described below in reference to FIG. 6, system 140 may, through an API of a third-party issuer system, obtain and encapsulate information specifying the one or more missing and eligible loyalty cards into a mobile wallet token for delivery to client device 104 and loading into user 110's mobile wallet.

FIG. 6 illustrates an exemplary process 600 for loading a mobile wallet with eligible loyalty products, in accordance with disclosed embodiments. In one embodiment, a system associated with a financial institution (e.g., system 140 of business entity 150) may be configured to identify eligible loyalty products that are missing from a mobile wallet, which may be established by a mobile application program executed by a device of a user (e.g., client device 104 of user 110). Further in certain aspects, system 140 may determine that one or more of the missing loyalty products are of potential interest to user 110 based on transaction data, and may interface with a third-party system (e.g., system 182 of third-party entity 192) to obtain the one or more missing loyalty products on behalf of user 110. In some embodiments, system 140 may execute software instructions that pre-load information specifying the one or more missing loyalty products into a mobile wallet token and transmit the pre-loaded mobile wallet token to client device 104, which may load the eligible loyalty products into a mobile wallet of user 110 for use in subsequent purchase transactions.

Referring to FIG. 6, in step 602, system 140 may identify one or more candidate loyalty products that are eligible for inclusion within a mobile wallet of user 110 (e.g., as established by a mobile wallet application executed by client device 104). For example, system 140 may access loyalty information that identifies candidate loyalty products eligible for use in mobile wallets established by mobile wallet applications provided by the financial institution (e.g., as stored in data repository 144), and may identify a subset of the candidate loyalty products in step 602 as being eligible for inclusion in user 110's mobile wallet.

In some aspects, the candidate loyalty products, but are not limited to, one or more loyalty and/or rewards cards issued by corresponding retailers or business entities (e.g., financial institutions issuing credit cards, such as American Express™) and eligible for use in purchase transactions at participating retailers. The loyalty products may, for example, be used to execute purchase transactions in conjunction with a payment product (e.g., a credit card or debit card), and additionally or alternatively, my accrue benefits that a user (e.g., user 110) may redeem for goods and services in lieu of the payment product. For example, loyalty products consistent with the disclosed embodiments may include a loyalty card issued by a coffee shop (e.g., Starbucks™) that, after use in a predetermined number of coffee purchases at Starbucks™, enables user 110 to obtain a free cup of Starbucks™ coffee.

By way of example, the candidate loyalty products may include at least one loyalty product issued by a third-party entity having a business relationship with the financial institution associated with system 140. In certain aspects, the business relationship may facilitate an exchange of information between system 140 and systems of the third-party entity (e.g., through a corresponding API). For example, as described below, the API may enable system 140 to enroll user 110 in a loyalty product issued by the third-party entity, and further, obtain information associated with the loyalty product for pre-loading into a mobile wallet token.

In other instances, the candidate loyalty products may include at least one loyalty product included within a mobile wallet of another customer of the financial institution (e.g., user 112). By way of example, system 140 may execute software instructions that determine, based on stored profile data (e.g., within data repository 144), that user 112 shares one or more demographic characteristics (e.g., age, income, etc.) with user 110, and thus, may select one of the loyalty products loaded into user 112's mobile wallet as a candidate loyalty product in step 602.

In some embodiments, system 140 may execute software instructions that obtain data identifying one or more loyalty products previously loaded into user 110's mobile wallet (e.g., in step 604), and further, identify one or more of the candidate loyalty products that are missing from user 110's mobile wallet (e.g., in step 606). For instance, in step 604, system may access mobile wallet data associated with user 110 (e.g., stored within cloud-based data repository 170), and may process the accessed mobile wallet data to identify one or more previously loaded loyalty products. In certain aspects, in step 606, system 140 may be configured to compare the previously loaded loyalty products against the candidate loyalty product information to identify the one or more candidate loyalty products missing from user 110's mobile wallet.

For example, system 140 may determine in step 602 that the candidate loyalty products include a loyalty cards issued by Safeway™ supermarkets, Starbucks™, and CVS/Pharmacy™, Based on an analysis of user 110's mobile wallet data in step 604, system 140 may determine that user 110's mobile wallet includes the CVS/Pharmacy™ loyalty card. In some aspects, system 140 determines in step 606 that the loyalty cards issued by Safeway™ supermarkets and Starbucks™ represent candidate loyalty cards missing from user 110's mobile wallet.

In an embodiment, system 140 may execute software instructions that process transaction data associated with user 110 to identify a subset of the missing loyalty products that are of potential interest to user 110 (e.g., in step 608). By way of example, system 140 may obtain transaction data associated with user 110 from a locally accessible data repository (e.g., transaction data stored within data repository 144), and the obtained transaction data may include data records identifying purchase transactions involving financial products of user 110 and corresponding retailers (e.g., transactional entities). Further, in some instances, system 140 may process the obtained transaction data records to identify purchase transactions involving corresponding ones of retailers and/or business entities that issue the missing loyalty products.

In certain aspects, system 140 may determine that a missing loyalty product is of potential interest to user 110 when user 110 executed greater than a threshold number of purchase transactions involving a retailer and/or business entity that issued the missing loyalty product during a pre-determined time period. In other aspects, system 140 may determine that the missing loyalty product is of potential interest to user 110 when a total value of purchase transactions involving user 110 during the predetermined time period exceeds a threshold value. The disclosed embodiments are, however, not limited to such exemplary metrics of potential interest, and in other embodiments, system 140 may determine a potential interest of user 110 in missing loyalty product based on any additional or alternate metric appropriate to the transaction data and to the loyalty product, including, but not limited to, types and number of purchased goods and services, particular time periods associated with the purchases, and purchases made at retail or markdown prices.

In some instances, the pre-determined time period, the threshold number, and/or the threshold value may be specified by user 110, e.g., as profile data provided during an initial registration process for digital banking or mobile wallet services provided by the financial institution associated with system 140. In other instances, system 140 may establish the pre-determined time period, the threshold number, and/or the threshold value based on one or more default values provided by the financial institution or a third-party entity that issues the missing loyalty product. Further, in some instances, system 140 may execute software instructions that adaptively determine pre-determined time period, the threshold number, and/or the threshold value based on the third-party entity that issues the missing loyalty product. For example, system 140 may establish a longer pre-determined time period and a larger threshold value for a loyalty product issued by Hilton™ Hotels than for a loyalty product issued by Starbucks™.

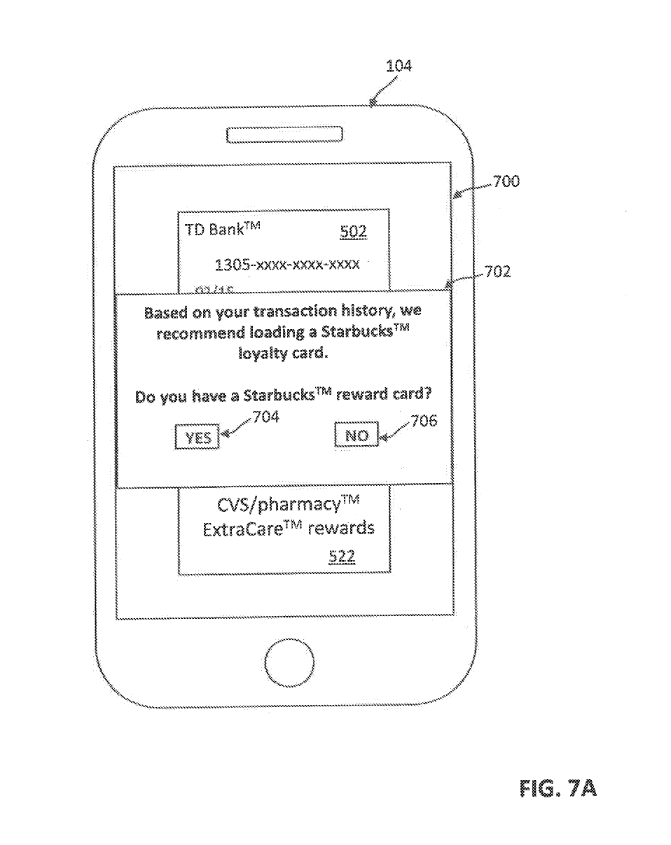

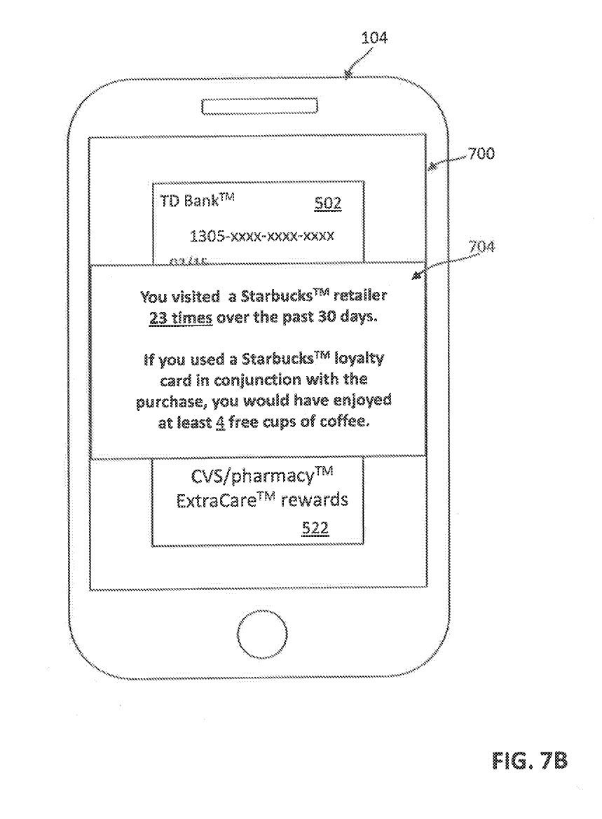

Referring back to FIG. 6, system 140 may generate a notification to user 110 that the subset of missing loyalty products may be of potential interest to user 110 based on user 110's prior purchase transactions, and may transmit the generated notification to client device 104 across network 120 using any of the communications protocols outlined above (e.g., in step 610). Client device 104 may, in some aspects, render the received notification for presentation within a graphical user interface (GUI) of a mobile wallet application executed by client device 104. By way of example, the presented notification may identify the missing loyalty products of potential interest to user 110, and may prompt user 110 to provide information to client device 104 confirming whether user 110 holds the missing and potentially interesting loyalty products, as described below in reference to FIG. 7A.

FIG. 7A illustrates an exemplary interface 700 for a mobile wallet application, in accordance with disclosed embodiments. In one embodiment, and as described above, system 140 may be configured to identify one or more eligible loyalty products that are missing from a mobile wallet of user 110 (e.g., as established by a mobile wallet application executed by client device 104), and further, that may be of potential interest to user 110 based on user 110's recent purchase transactions. In some aspects, system 140 may transmit, to client device 104, a notification identifying the missing loyalty products of potential interest, and prompting user 110 to indicate whether or not user 110 already holds the missing loyalty products. Upon receipt, client device 104 may render the notification for presentation to user 110 within interface 700.

For example, using the processes described above, system 140 may determine that eligible loyalty cards issued by Safeway™ supermarkets and Starbucks™ are missing from user 110's mobile wallet. Further, and based on an analysis of transaction data records associated with user 110, system 140 may determine that user 110 visited a local Starbucks™ retailer twenty-three times in the past thirty days, but only visited a local Safeway™ three times within the past thirty days. In certain aspects, system 140 may determine that a loyalty product is of potential interest to user 110 when user 110 makes purchases from a corresponding issuing retailer at least eight times in the last thirty days (e.g., at least twice each week). System 140 may, in some instances, determine that the Starbucks™ loyalty card is of potential interest to user 110, and may transmit a notification prompting user 110 to indicate whether he or she already holds the Starbucks™ loyalty card.

As depicted in FIG. 7A, client device 104 may present the notification in a pop-up window 702 displayed within a portion of interface 700, and in some aspects, pop-up window may obscure a portion of one or more other visual elements presented within interface 700 (e.g., visual indicators 502 and 522 described above in reference to FIG. 5). Pop-up window 702 may, for example, indicate that system 140 recommends loading a Starbucks™ loyalty card into user 110's mobile wallet based on user 110's recent transaction history, and further, may prompt user 110 provide input to client device 104 indicating whether user 110 already holds the Starbucks™ loyalty card. In other aspects, system 140 may provide client device 104 with additional data indicative of the relevance of the Starbucks card (e.g., a total number of visits over the past thirty days, a total value of purchases over the past thirty days, etc.), which client device 104 may present to user 110 via pop-up window 702.

If user 110 already holds the Starbucks™ loyalty card, user 110 may tap, click, or otherwise select region 704 of pop-up window 702 to provide information indicative of the existing Starbucks™ loyalty card. In certain aspects, client device 104 may be configured to present an additional interface to user 110 enabling user 110 to provide information specifying the existing Starbucks™ loyalty card, which may be processed by the mobile wallet application to load the Starbucks™ loyalty card into user 110's mobile wallet. For example, the specified information may include, but is not limited to, an account number associated with the rewards or loyalty card, a full name of the card holder, and/or an address associate with the cardholder. In response to the specified information, the mobile wallet application executed by client device 104 may load the Starbucks™ loyalty card for future purchases of food and beverages, and may present within interface 700 a visual indicator of the Starbucks™ loyalty card. Client device 104 may also be configured to transmit the information specifying the existing Starbucks™ loyalty card to system 140 as a response to the transmitted notification.

If, however, user 110 does not already hold the Starbucks™ loyalty card, user 110 may tap, click, or otherwise select region 706 of pop-up window 702 to provide input indicative of the absence of the Starbucks™ loyalty card. Client device 104 may also be configured to transmit information identifying user 110's lack of a Starbucks™ loyalty card to system 140 as a response to the transmitted notification.

Referring back to FIG. 6, system 140 may be configured to receive a response to the transmitted notification from client device 104 (e.g., in step 612), and may determine based on the response whether user 110 holds one or more of the missing loyalty product of potential user interest (e.g., step 614). If system 140 finds that user 110 fails to hold any of the missing loyalty products of potential user interest (e.g., step 614; NO), system 140 may identify one or more lost opportunities or benefits that user 110 would otherwise accrue had the missing loyalty products been included within user 110's mobile wallet and used in corresponding purchase transactions (e.g., in step 616).

For example, and as described above, the missing loyalty products may include a Starbucks™ loyalty card, and system 140 may determine that user 110 visited a local Starbucks™ retailer twenty-three times in the past thirty days. Further, system 140 may determine that, had user 110's mobile wallet included the Starbucks™ loyalty card, user 110 would have accumulated rewards redeemable for at least four cups of Starbucks™ coffee.

In some aspects, system 140 may be configured to generate a notification that identifies the lost opportunities and benefits (e.g., as determined in step 616), which may be transmitted to client device 104 using any of the communication protocols outlined above (e.g., in step 618). In certain aspects, client device 104 may receive the notification, and as described above, any may render the received notification for presentation within an GUI of the mobile wallet application, as illustrated in FIG. 7B.

FIG. 7B illustrates another exemplary interface 700 for a mobile wallet application, in accordance with disclosed embodiments. In some instances, client device 104 may receive a notification of one or more opportunities and/or benefits lost due to the absence of the loyalty product or products in user 110's mobile wallet, and as depicted in FIG. 7B, may display the notification in a pop-up window 704 displayed within a portion of interface 700. For example, system 140 may determine a Starbucks™ loyalty card is missing from user 110's mobile wallet and is not currently held by user 110. In some aspects, and based on the twenty-three visits to the local Starbucks™ over the past thirty days, system 140 may determine that user 110 lost approximately four complimentary cups of coffee that would otherwise be provided through the Starbucks™ loyalty card.

Referring back to FIG. 6, in step 620, system 140 may execute software instructions that store information identifying the lost opportunities and/or benefits (e.g., missed opportunity information) within a locally accessible data repository (e.g., data repository 144 and/or cloud-based data repository 170). For example, the missed opportunity information may include, but is not limited, to, data records identifying corresponding ones of the missing loyalty cards, the opportunities and/or benefits lost due to the missing loyalty cards, the issuing retailers or business entities, and information linking user 110 to the missing loyalty products. In some aspects, system 140 may be configured to provide at least a portion of the missed opportunity information to a system of a third-party loyalty partner (e.g., system 182 of third-party entity 192), which may automatically enroll user 110 into loyalty programs associated with the missing loyalty products, and provide information associated with the missing loyalty products (e.g., account numbers, cardholder names, etc.) for encapsulation into a mobile wallet token, as described below. In some aspects, process 600 is then complete in step 622.

Referring back to step 614, system 140 may to determine that user 110 currently holds at least one of the missing loyalty products of potential user interest (e.g., step 614; YES), and system 140 may process the received response to identify the at least one missing loyalty product held by user 110 to extract the financial product information associated with the at least one missing loyalty product from the received response (e.g., in step 624).

In step 626, system 140 may, in some instances, execute software processes that update mobile wallet data associated with user 110 (e.g., as stored within cloud-based data repository 170) to reflect the at least one missing loyalty product held by user 110 and newly loaded into user 110's mobile wallet. For example, if system 140 were to determine, based on the received response, that user 110 already holds the Starbucks™ loyalty card, system 140 may extract from the response the information associated with the Starbucks™ loyalty card (e.g., that user 110 provided as input to client device 104 upon selecting “YES” indicator 704 of FIG. 7A). System 140 may, in some instances, update the stored mobile wallet data for user 110 to include information identifying the newly loaded Starbucks™ loyalty card.

System 140 may further determine, based on the response received in step 614, whether user 110 fails to hold remaining ones of the missing loyalty products (e.g., in step 628). For example, although user 110 may hold a Starbucks™ loyalty card, which may be of interest to user 110 based on user 110's recent purchases, user 110 may not currently hold a rewards card issues by Indigo™ books, which system 140 also identified of potential interest to user 110 based on user 110's recent purchase transactions.

If system 140 were to determine that user 110 fails to hold any remaining missing loyalty products (e.g., step 628; YES), process 600 may pass back to step 616, and system 140 may identify opportunities and/or benefits lost due to the remaining missing loyalty products, as described above. If, however, system 140 were to determine that user 110 currently holds each of the missing loyalty products of potential interest (e.g., step 628; NO), exemplary process 600 may pass back to step 622, and process 600 may be complete.

In the embodiments described above, system 140 may identify one or more eligible loyalty products that are missing from user 110's mobile wallet, further, that are of potential interest to user 110 based on one or more recently purchases made by user 110. In some aspects, system 140 may determine, based input from user 110 received via client device 104, whether user 110 holds any of the missing loyalty products that are absent from user 110's mobile wallet. When the missing loyalty products are relevant to user 110's resent purchases, and further, are not currently held by user 110, system 140 may provide information to client device 104 that alerts user 110 the opportunities and benefits lost due to the missing loyalty products.

In some aspects, user 110 may, in response to the information, acquire one or more of the missing loyalty products and provide, to client device 104, information that enables a mobile wallet application to load the newly accessed loyalty products into user 110's mobile wallet. For example, user 110 may, via client device 104, access a web page or digital portal associated with a missing Starbucks™ loyalty card, may obtain access to the Starbucks™ loyalty card, and further, may provide information specifying the Starbucks™ loyalty card (e.g., an account number, a cardholder name, and associated physical or email address) to client device 104, thus enable the executed mobile wallet application to load the Starbucks™ loyalty card into user 110's mobile wallet.

In other aspects, however, the financial institution associated with system 140 may establish business relationships with issuers of one or more of the missing loyalty cards. In some embodiments, the established business relationships may enable system 140 to automatically enroll user 110 into a loyalty program associated with one or more of the missing loyalty cards, and upon receipt of confirmation, encapsulate and pre-load information specifying the loyalty program and associated loyalty product into a mobile wallet token, which may be processed by client device 104 to load the new loyalty product into user 110's mobile wallet. In some instances, the automated enrollment into a loyalty program and the pre-loading of a corresponding loyalty product into user 110's mobile wallet may overcome many obstacles of the obstacles limiting the wider adoption of mobile wallets and other mobile payment systems.

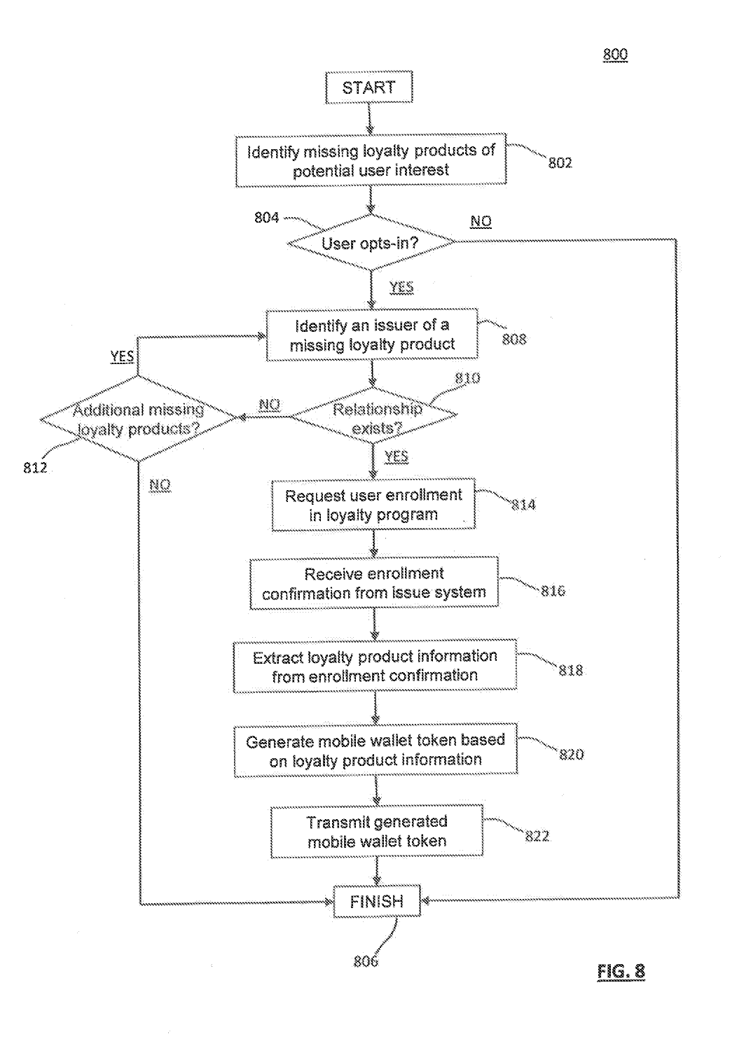

FIG. 8 illustrates an exemplary process 800 for adaptively loading a mobile wallet with one or more eligible loyalty products, in accordance with disclosed embodiments. In one embodiment, a system associated with a financial institution (e.g., system 140 associated with business entity 150) may be configured to obtain information identifying an eligible loyalty product missing from a mobile wallet of a user (e.g., user 110) and relevant to user 110's recent purchases. When a business relationship exists between the financial institution and an issuer of the missing loyalty product, system 140 may be configured to exchange information a system associated with the issuer to enroll user 110 in a loyalty program associated with the missing loyalty product, and further, to obtain information that enables system 140 to pre-load the previously missing loyalty product into user 110's mobile wallet.

In some aspects, and as described above, the missing loyalty products, may include, but are not limited to, one or more loyalty and/or rewards cards issued by corresponding retailers or business entities (e.g., financial institutions issuing credit cards, such as American Express™) and eligible for use in purchase transactions at participating retailers. The loyalty products may, for example, be used to execute purchase transactions in conjunction with an additional payment product (e.g., a credit card or debit card), and additionally or alternatively, my accrue benefits that a user (e.g., user 110) may redeem for goods and services in lieu of the additional payment product. For example, loyalty products consistent with the disclosed embodiments held by user 110 may include a loyalty card issued by a coffee shop (e.g., Starbucks™) that, after use in a predetermined number of coffee purchases at Starbucks™, enables user 110 to obtain a free cup of Starbucks™ coffee.

Referring to FIG. 8, in step 802, system 140 may access data identifying one or more loyalty products missing from user 110's mobile wallet and of potential interest to user 110 based on recent purchase transactions. For example, system 140 may access missed opportunity data for user 110 that is stored in a locally accessible data repository (e.g., data repository 144 and/or cloud-based data repository 170), and which may specify one or more missing loyalty programs and corresponding issuers (e.g., retailers and/or business entities) associated with user 110.

In some aspects, system 140 may determine whether user 110 opted-in to mobile wallet services that share information associated with user 110 with one or more third-party entities that issue loyalty product eligible for but missing from user 110's mobile wallet (e.g., in step 804). By way of example, system 140 may access locally stored data (e.g., user profile data stored within data repository 144) to determine whether terms and conditions accepted by user 110 include information identifying processes that share user information with third-party loyalty partners in accordance with an established business relationship.

If system 140 finds that user 110 did not opt-in to share data with third-party loyalty partners (e.g., step 804; NO), process 800 may be complete in step 806.

If, however, system 140 determines that user 110 opted-in to mobile wallet services that share data with third-party loyalty partners (e.g., step 804; YES), system 140 may identify an issuer of a corresponding one of the missing loyalty products (e.g., in step 808). For example, as described above, system 140 may identify an issuer associated with a missing loyalty product within the accessed missed opportunity data. As described above, the identified issuer may include a retailer or other business entity that provides a loyalty or rewards card available to user 110 and eligible for inclusion in user 110's mobile wallet.

System 140 may determine in step 810 whether a business relationship exists between the financial institution associated with system 140 and the identified issuer. In certain aspects, issuers of loyalty programs may enter into a business relationship with the financial institution to obtain information identifying customers (e.g., user 110) who would benefit from loyalty products provided by the issuers (e.g., based on recent purchases of goods and services from participating retailers), but who do not currently hold the loyalty products, either physically or in mobile wallets. In some aspects; the issuer may provide a cash payment to the financial institution associated with system 140 for each customer identified by system 140. Alternatively, in other aspects, the issuers may provide cash payments to the financial instruction only when a referred customer enrolls in a loyalty program and obtains a new or updated loyalty product from the issuer.

If system 140 were to determine that a business relationship does not exist between the identified issuer and the financial institution (e.g., step 810; NO), system 140 may be configured to determine whether additional missing loyalty products exist within the accessed missing loyalty product information (e.g., in step 812). If system 140 finds that the missing loyalty product information includes additional loyalty products (e.g., step 812; YES), process 800 may pass back to step 808, and system 140 may identify an additional one of the missing loyalty products for analysis. Alternatively, if system 140 determines that no additional missing loyalty products require analysis (e.g., step 812; NO), then process 800 is complete in step 806.

If, however, system 140 were to determine that a business relationship exists between the identified issuer and the financial institution (e.g., step 810; YES), system 140 may execute software instructions that transmit, to a system associated with the identified issuer (e.g., system 182), a request to enroll user 110 in a loyalty program associated with the corresponding missing loyalty product (e.g., in step 814). In certain aspects, system 140 may deliver the information identifying user 110 to the issuer system through a corresponding open API established by the issuer system and made available to system 140. By way of example, the transmitted request may identify the missing loyalty product, information identifying user 110 (e.g., user 110's full name, a mailing address, one or more government-issued identifiers (e.g., a driver's license number, etc.)), and any additional or alternate information appropriate to the API and required by the issuer system to enroll user 110 into the loyalty program corresponding to the missing loyalty product. Further, in some aspects, the issuer system may establish the open API in accordance with one or more term and conditions of its business relationship with the financial institution.

In some embodiments, system 182 may receive the request from system 140, and may process the information identifying the missing loyalty product and the information identifying user 110 to enroll user 110 in the loyalty program corresponding to the missing loyalty product. By way of example, system 140 may provide, to a system associated with Starbucks™ (e.g., system 182), a request to enroll user 110 in a loyalty program corresponding to a Starbucks™ loyalty card missing from user 110's mobile wallet. In some embodiments, the system 182 may determine whether user 110 is eligible for the Starbucks™ loyalty program, and if so, generate one or more product credentials for the Starbucks™ loyalty card. For example, the product credentials may include an account number associated with the Starbucks™ loyalty card, a full name and mailing address of the cardholder (e.g., user 110), and further, an email address or other mechanism for electronically communicating with the cardholder. In some aspects, upon enrolling user 110 into the corresponding loyalty program, the issuer system may generate a confirmation message identifying the missing loyalty product and the product credentials for the missing loyalty product, which may be transmitted to system 140 across network 120 using any of the communications protocols outlined above.

Referring to FIG. 8, system 140 may receive the confirmation message from system 182 (e.g., in step 816), and may extract information specifying the missing loyalty product from the confirmation message (e.g., in step 818). In some aspects, the information specifying the missing loyalty product may include a threshold amount of information required by a mobile wallet application executing at client device 104 to load the missing loyalty product into user 110's mobile wallet (e.g., at least an account number, a full name of the card holder, and a card holder address).

Further, in some aspects, system 140 may execute software instructions that encapsulate the information specifying the missing loyalty product to form a mobile wallet token for user 110 (e.g., in step 820). In some embodiments, in step 818, system 140 may format the delegated financial product information in accordance with one or more requirements of a corresponding mobile wallet application provided by system 140, and may encrypt the formatted information using a public key value specific to user 112 and to client device 106. As described above, system 140 may be configured to encrypt the formatted information using a previously generated public key value, or generate the public key value based, for example, information identifying user 110 (e.g., a user name or user identifier) and/or information identifying client device 104 (e.g., a MAC address, an IP address, an International Mobile Equipment Identification (IMEI) number, and/or a Mobile Equipment ID (MEID) number).

System 140 may be configured to transmit the conditional mobile wallet token to client device 104 using one or more of the processes outlined above (e.g., in step 822), and a mobile wallet application executed on client device 106 may be configured to decrypt, unpack, and load the delegated financial product into a mobile wallet of user 110 maintained at client device 104. In some aspects, user 110 may employ the previously missing loyalty product in purchases of goods and/or services during in conjunction with or in lieu of one or more additional loaded payment products. Further, the disclosed embodiments may enable system 140 to pre-load missing loyalty products that provide tangible benefits to user 110 into user 110's mobile wallet without requiring the multiple-step processes often perform by user of mobile wallets and other payment products.

Although the disclosed embodiments are described in terms of specific payment products and specific loyalty and rewards programs, the disclosed embodiments are not limited to such exemplary products and programs, and in additional embodiments, system 140 may be configured to facilitate a delegation of any additional or alternate financial products eligible for inclusion within mobile wallets associated with users 110 and 112, and established by mobile wallet applications executed by on client devices 104 and 106. Further, the disclosed embodiments are not limited to the exemplary termination conditions outlined above, and in other instances, system 140 may enable user 110 to specify any additional or alternate termination conditions appropriate to the delegated financial products and capable of being monitored by system 140

Various embodiments have been described herein with reference to the accompanying drawings. It will, however, be evident that various modifications and changes may be made thereto, and additional embodiments may be implemented, without departing from the broader scope of the disclosed embodiments as set forth in the claims that follow.

Further, other embodiments will be apparent to those skilled in the art from consideration of the specification and practice of one or more embodiments of the present disclosure. It is intended, therefore, that this disclosure and the examples herein be considered as exemplary only, with a true scope and spirit of the disclosed embodiments being indicated by the following listing of exemplary claims.

What is claimed is:

1. An apparatus, comprising:
at least one processor; and
a memory storing executable instructions that, when executed by the at least one processor, causes the at least one processor to perform the steps of:
identifying one or more financial products of potential interest to a user, the identification being based on transaction data associated with the user, and the financial products being eligible for inclusion within a mobile wallet administered by an application program executed by a device of user;
determining whether the user holds a corresponding one of the financial products;
when the user fails to hold the corresponding financial product, transmitting, to a system associated with an issuer of the corresponding financial product, a request to acquire the corresponding financial product on behalf of the user;
receiving, from the issuer system, information associated with the corresponding financial product acquired on behalf the user;
generating a mobile wallet token based at least the information identifying the corresponding financial product; and
transmitting the generated mobile wallet token to the user device.

2. The apparatus of claim 1, wherein the financial products comprises at least one loyalty product.

3. The apparatus of claim 1, wherein the executed instructions further cause the at least one processor to perform the steps of:
obtaining information identifying (i) one or more candidate financial products available for inclusion within the mobile wallet, and (ii) one or more financial products included within the mobile wallet;
filtering the candidate financial products to exclude at least one of the financial products included within the mobile wallet.

4. The apparatus of claim 3, wherein the executed instructions further cause the at least one processor to perform the step of establishing one or more of the filtered candidate financial products as the one or more financial products of potential interest to the user.

5. The apparatus of claim 4, wherein the transaction data identifies purchase transactions between the user and one or more transactional entities

6. The apparatus of claim 5, wherein the executed instructions further cause the at least one processor to perform the steps of:
identifying a subset of the purchase transactions associated with a transactional entity matching an issuer of a corresponding one of the candidate financial products;
determining whether the identified subset satisfies a threshold condition associated with the purchase transactions; and
when the identified subset satisfies the threshold condition, establishing the corresponding candidate financial product as a financial product of potential interest to the user.

7. The apparatus of claim 6, wherein:
the threshold condition identifies a threshold number of purchase transactions; and
the identifying further comprises:
determining whether the identified subset includes at least the threshold number of purchase transactions; and
when the identified subset includes at least the threshold number of purchase transactions, establishing the corresponding candidate financial product as the financial product of potential interest to the user.

8. The apparatus of claim 6, wherein:
the threshold condition identifies a threshold value of the purchase transactions; and
the executed instructions further cause the at least one processor to perform the steps of:
determining whether a value associated with the identified subset exceeds the threshold value; and
when the identified subset value exceeds the threshold value, establishing the corresponding candidate financial product as the financial product of potential interest to the user.

9. The apparatus of claim 1, wherein the executed instructions further cause the at least one processor to perform the steps of:
transmitting, to the user device, information identifying the one or more financial products of potential interest to the user; and
receiving a response to the transmitted information from the user device, the response confirming whether the user holds the one or more financial products.

10. The apparatus of claim 9, wherein the executed instructions further cause the at least one processor to perform the step of determining whether the user holds the corresponding one of the financial products based on the received response.

11. The apparatus of claim 1, wherein the one or more financial products of interest to the user are missing from the mobile wallet.

12. The apparatus of claim 11, wherein the executed instructions further cause the at least one processor to perform the step of obtaining, when the user holds the corresponding financial product, information identifying corresponding financial product from the user device, the corresponding financial product being loaded into the mobile wallet by the application program executed by the mobile device.

13. The apparatus of claim 11, wherein the executed instructions further cause the at least one processor to perform the steps of:
when the user fails to hold the corresponding financial product, identifying at least one of a lost opportunity or lost benefit associated with the corresponding financial product; and
transmitting information identifying the at least one of lost opportunity or lost benefit to the user device, the user device being configured to present the at least one lost opportunity or lost benefit to the user.

14. A computer-implemented method, comprising:
identifying, using at least one processor, one or more financial products of potential interest to a user, the identification being based on transaction data associated with the user, and the financial products being eligible for inclusion within a mobile wallet administered by an application program executed by a device of user;
determining, using the at least one processor, whether the user holds a corresponding one of the financial products;
when the user fails to hold the corresponding financial product, transmitting, using the at least one processor, and to a system associated with an issuer of the corresponding financial product, a request to acquire the corresponding financial product on behalf of the user;
receiving, using the at least one processor, and from the issuer system, information associated with the corresponding financial product acquired on behalf the user;
generating, using the at least one processor, a mobile wallet token based at least the information identifying the corresponding financial product; and
transmitting, using the at least one processor, the generated mobile wallet token to the user device.

15. The method of claim 14, wherein the financial products comprise at least one loyalty product.

16. The method of claim 14, wherein:
the transaction data identifies purchase transactions between the user and one or more transactional entities; and
the identifying further comprises:
identifying a subset of the purchase transactions associated with a transactional entity matching an issuer of a corresponding one of the candidate financial products;
determining whether the identified subset satisfies a threshold condition associated with the purchase transactions; and
when the identified subset satisfies the threshold condition, establishing the corresponding candidate financial product as a financial product of potential interest to the user.

17. The method of claim 16, wherein:
the threshold condition identifies a threshold number of purchase transactions; and
the identifying further comprises:
determining whether the identified subset includes at least the threshold number of purchase transactions; and
when the identified subset includes at least the threshold number of purchase transactions, establishing the corresponding candidate financial product as the financial product of potential interest to the user.

18. The method of claim 16, wherein:
the threshold condition identifies a threshold value of the purchase transactions; and
the identifying further comprises:
determining whether a value associated with the identified subset exceeds the threshold value; and
when the identified subset value exceeds the threshold value, establishing the corresponding candidate financial product as the financial product of potential interest to the user.

19. The method of claim 14, further comprising:
transmitting, to the user device, information identifying the one or more financial products of potential interest to the user;
receiving a response to the transmitted information from the user device, the response confirming whether the user holds the one or more financial products; and
determining whether the user holds the corresponding one of the financial products based on the received response.

20. A tangible, non-transitory computer-readable medium storing instructions that, when executed by at least one processor, cause the at least one processor to perform a method, comprising:
identifying one or more financial products of potential interest to a user, the identification being based on transaction data identifying one or more purchase transactions involving the user, and the financial products being eligible for inclusion within a mobile wallet administered by an application program executed by a device of user;
determining whether the user holds a corresponding one of the financial products;
when the user fails to hold the corresponding financial product, transmitting, to a system associated with an issuer of the corresponding financial product, a request to acquire the corresponding financial product on behalf of the user;
receiving, from the issuer system, information associated with the corresponding financial product acquired on behalf the user;
generating a mobile wallet token based at least the information identifying the corresponding financial product; and
transmitting the generated mobile wallet token to the user device.
